(19) United States
(12) Patent Application Publication
(10) Pub. No.: US 2026/0040114 A1
(43) Pub. Date: Feb. 5, 2026

(54) METHODS, ARCHITECTURES, APPARATUSES AND SYSTEMS FOR MOBILE OBJECT DETECTION OVER WIRELESS NETWORKS

(71) Applicant: InterDigital Patent Holdings, Inc., Wilmington, DE (US)

(72) Inventors: Fumihiro Hasegawa, Westmount (CA); Paul Marinier, Brossard (CA); Moon-il Lee, Melville, NY (US); Ghyslain Pelletier, Montreal (CA); Remun Koirala, London (GB); Tao Deng, New York, NY (US)

(21) Appl. No.: 18/794,682

(22) Filed: Aug. 5, 2024

(51) Int. Cl. H04W 24/10; H04B 17/318; H04L 5/00

(52) U.S. Cl. CPC H04W 24/10; H04B 17/328; H04L 5/0007

(57) ABSTRACT

Procedures, methods, architectures, apparatuses, systems, devices, and computer program products are provided for object detection over a wireless network. A method performed by a wireless transmit/receive unit (WTRU) includes receiving, from a wireless network, a configuration that includes time windows during which the WTRU performs sensing measurements based on the periodic downlink reference signals, where each time window includes a measurement range, and a trigger condition associated with reporting the sensing measurements to the wireless network. The method also includes receiving periodic downlink reference signals. The method also includes performing sensing measurements during at least a present time window and a prior time window of the time windows, comparing sensing measurements of the measurement range of the present time window to sensing measurements of the measurement range of the prior time window, and in response to the comparison satisfying the trigger condition, reporting the sensing measurements to a wireless network.

### TECHNICAL FIELD

The present disclosure is generally directed to the fields of communications, software and encoding, including, for example, to methods, architectures, apparatuses, systems related to integrated sensing and communication (ISAC) (e.g., detecting a target object based on configuration of at least one of a wireless transmit/receive unit or a wireless network).

### BACKGROUND

An object may be detected using a device (e.g., a user equipment) communicatively coupled to a wireless network, and the device may report sensing-related measurements to the wireless network.

### SUMMARY

In accordance with certain embodiments of the present disclosure, a method is performed by a wireless transmit/receive unit (WTRU). The method includes receiving, from a wireless network, a configuration that includes time windows during which the WTRU performs one or more sensing measurements based on periodic downlink reference signals, where each time window includes a measurement range, and a trigger condition associated with reporting the one or more sensing measurements to the wireless network. The method also includes receiving, from the wireless network, the periodic downlink reference signals. The method also includes performing one or more sensing measurements during at least a present time window and a prior time window of the time windows, comparing one or more sensing measurements of the measurement range of the present time window to one or more sensing measurements of the measurement range of the prior time window, and in response to the comparison satisfying the trigger condition, reporting the one or more sensing measurements to the wireless network.

In certain representative embodiments of the method, the configuration further includes any one or more of a measurement granularity or a maximum number of measurements per report associated with the one or more sensing measurements, and the measurement range includes a portion of a cyclic prefix associated with the time window, or a portion of an orthogonal frequency division multiplexing symbol length associated with the time window.

In certain representative embodiments of the method, if the configuration does not include the measurement range as a subset of a respective time window, then performing the one or more sensing measurements is based on a maximum measurement range associated with the time windows.

In certain representative embodiments of the method, if the trigger condition does not include a measurement power threshold, then the reporting includes a reference signal received power at each of the one or more sensing measurements.

In certain representative embodiments of the method, comparing the one or more sensing measurements includes calculating at least one a difference between at least one reference signal received power associated with the measurement range of the present time window and at least one reference signal received power associated with the measurement range of the prior time window, satisfying the trigger condition includes the at least one difference exceeding a threshold, and if the at least one difference exceeds the threshold, the reporting includes the at least one reference signal received power associated with the measurement range of the present time window, a reference time, and at least one relative sample time associated with the at least one reference signal received power associated with the measurement range of the present time window.

In certain representative embodiments of the method, the configuration further includes a maximum number of measurement instances to be included in the report, and reporting the one or more sensing measurements includes reporting respective one or more sensing measurements for each measurement instance of the maximum number of measurement instances.

In certain representative embodiments of the method, the configuration is based on a sensing capability of the WTRU, the sensing capability including at least one of: a capability to make measurements on specific types of downlink reference signals, a capable measurement periodicity, a capable reporting periodicity; a capability to perform simultaneous sensing and communication, a capability to determine location information of the WTRU, or a supported sensing type.

In certain representative embodiments of the method, the comparing and the reporting occur during or after the present time window.

In certain representative embodiments, receiving the periodic downlink reference signals includes receiving a first periodic downlink reference signal at a plurality of times, and performing the one or more sensing measurements includes determining respective time differences between the plurality of times.

In certain representative embodiments of the method, the trigger condition includes a threshold difference between one or more sensing measurements of the present time window and a corresponding one or more sensing measurements of the prior time window.

In certain representative embodiments of the method, the trigger condition is based on any one or more of: a time of arrival, an angle of arrival, a spatial measurement, a power measurement, a Doppler measurement, or a phase measurement.

In accordance with certain embodiments of the present disclosure, a wireless transmit/receive unit (WTRU) includes a processer, and a transceiver coupled to the processer. The WTRU is configured to receive, from a wireless network, a configuration that includes time windows during which the WTRU performs one or more sensing measurements based on periodic downlink reference signals, where each time window includes a measurement range, and a trigger condition associated with reporting the one or more sensing measurements to the wireless network. The WTRU is also configured to receive, from the wireless network, the periodic downlink reference signals. The WTRU is also configured to perform one or more sensing measurements during at least a present time window and a prior time window of the time windows, compare one or more sensing measurements of the measurement range of the present time window to one or more sensing measurements of the measurement range of the prior time window, and in response to the comparison satisfying the trigger condition, report the one or more sensing measurements to the wireless network.

In certain representative embodiments of the WTRU, the configuration further includes any one or more of a measurement granularity or a maximum number of measurements per report associated with the one or more sensing measurements, and the measurement range includes a portion of a cyclic prefix associated with the time window, or a portion of an orthogonal frequency division multiplexing symbol length associated with the time window.

In certain representative embodiments of the WTRU, if the configuration does not include the measurement range as a subset of a respective time window, then the WTRU is further configured to then perform the one or more sensing measurements based on a maximum measurement range associated with the time windows.

In certain representative embodiments of the WTRU, to compare the one or more sensing measurements includes calculating at least one difference between a reference signal received power associated with the measurement range of the present time window and at least one reference signal received power associated with the measurement range of the prior time window, satisfying the trigger condition includes the at least one difference exceeding a threshold, and if the at least one difference exceeds the threshold, then the report includes the at least one reference signal received power associated with the measurement range of the present time window, a reference time, and at least one relative sample time associated with the at least one reference signal received power associated with the measurement range of the present time window.

In certain representative embodiments of the WTRU, the configuration further includes a maximum number of measurement instances to be included in the report, and to report the one or more sensing measurements includes reporting respective one or more sensing measurements for each measurement instance of the maximum number of measurement instances.

In certain representative embodiments of the WTRU, the configuration is based on a sensing capability of the WTRU, the sensing capability including at least one of: a capability to make measurements on specific types of downlink reference signals; a capable measurement periodicity, a capable reporting periodicity; a capability to perform simultaneous sensing and communication, a capability to determine location information of the WTRU, a capability to provide Doppler information (e.g., based on at least one reflection by a mobile object), or a supported sensing type.

In certain representative embodiments of the WTRU, the comparing and the reporting occur during or after the present time window.

In certain representative embodiments of the WTRU, to receive the periodic downlink reference signals includes receiving a first periodic downlink reference signal at a plurality of times, and to perform the one or more sensing measurements includes determining respective time differences between the plurality of times.

In certain representative embodiments of the WTRU, the trigger condition includes a threshold difference between one or more sensing measurements of the present time window and a corresponding one or more sensing measurements of the prior time window, and is based on any one or more of: a time of arrival, an angle of arrival, a spatial measurement, a power measurement, a Doppler measurement, or a phase measurement.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative depiction of how a mobile object can block a line-of-sight path between a wireless transmission point and user equipment;

FIG. 3 shows illustrative interactions between a wireless network and user equipment for initiating sensing;

FIG. 4 shows illustrative interactions between a wireless network and user equipment for obtaining one or more reference signal configurations for sensing;

FIG. 5 shows illustrative configurations of monitoring windows for sensing;

FIG. 6 shows an illustrative downlink reference signal configuration that user equipment may receive;

FIG. 7 show an illustrative periodicity associated with a reference signal and received by user equipment;

FIG. 8 shows an illustrative example of a reference signal arriving multiple times at user equipment;

FIG. 9 shows illustrative timing configurations of a reference signal to be used by user equipment;

FIG. 10 shows an illustrative event for which user equipment reports Doppler information;

FIG. 11 shows an illustrative example of a reference signal having more than one angle of arrival at a single time of arrival;

FIG. 12 shows an illustrative sequence of measurement instances and a corresponding reporting of power differences;

FIG. 13 shows an illustrative sequence of measurement instances and a corresponding reporting of phase differences;

FIG. 14 shows an illustrative sequence of measurement instances and corresponding reporting of angles of arrival;

FIG. 15 shows an illustrative sequence of measurement instances and corresponding measurement ranges;

FIG. 16 shows an illustrative sequence of measurement instances with moving measurement windows;

FIG. 17 shows an illustrative example of a measurement report;

FIG. 18 shows an illustrative example of multiple times associated with user equipment measurements;

FIG. 19 shows an illustrative example of user equipment determining to activate a certain measurement window to achieve a more granular measurement; and

FIG. 20 shows an illustrative method for using user equipment to make and report sensing measurements.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

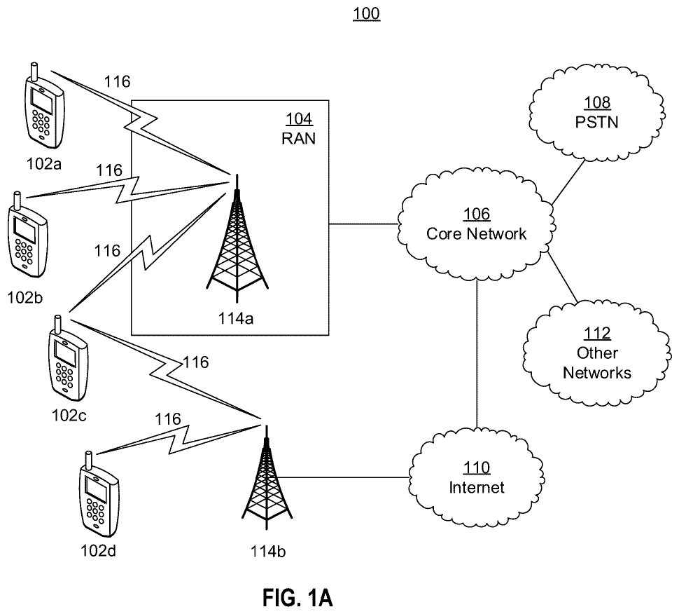

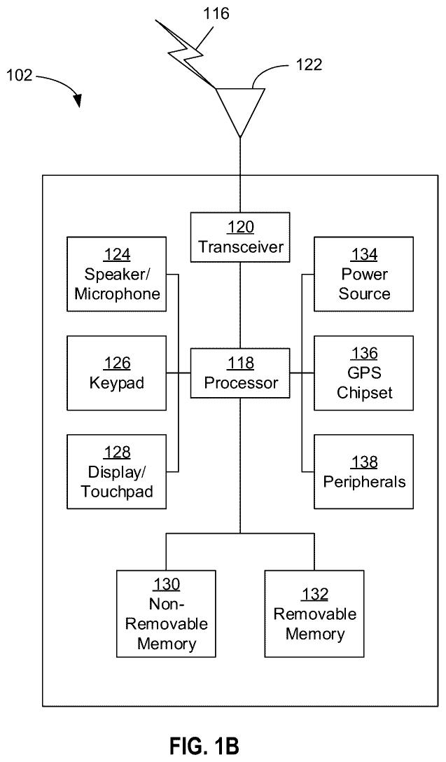

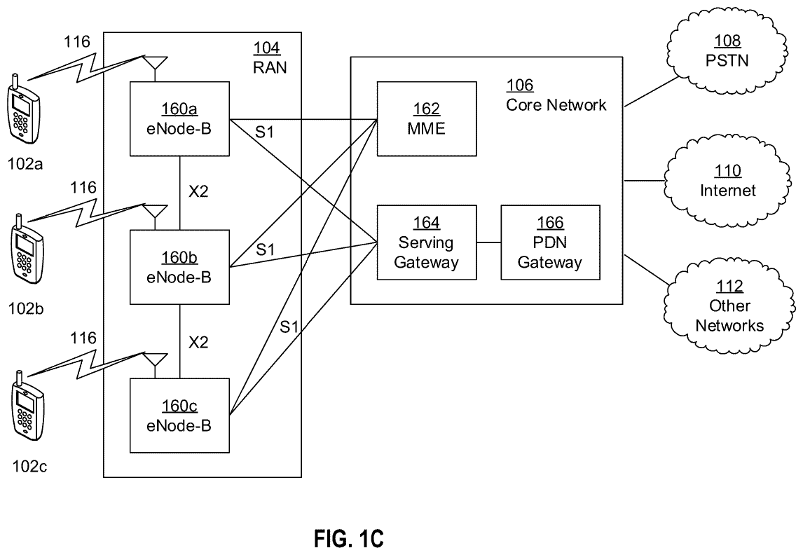

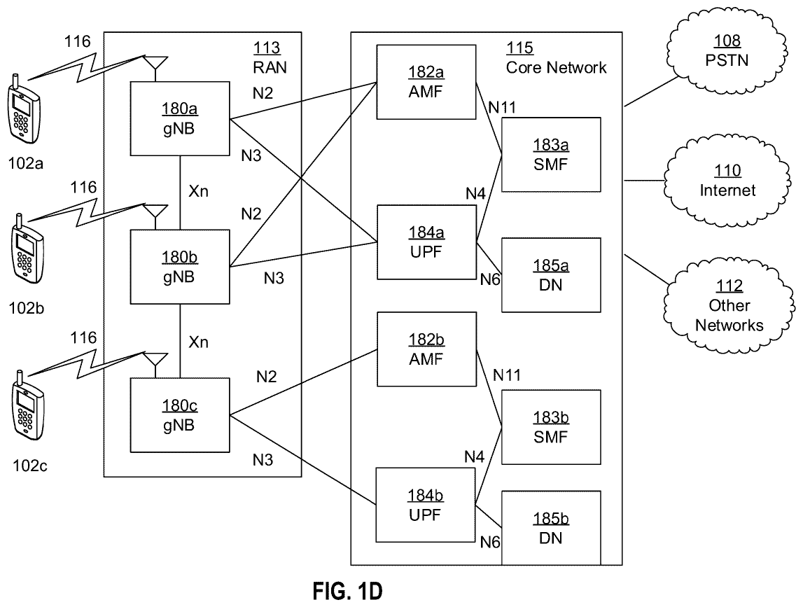

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11c DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHz, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain embodiments of the present disclosure, the devices, systems, architectures, communication links, apparatuses, and other elements depicted in FIGS. 1A-1D may be used in connection with sensing a mobile object and determining when to report sensing of a mobile object. As may be used in connection with certain embodiments of the present disclosure, some additional terminology (beyond that which is provided above) is provided above.

“WTRU” (wireless transmit receive unit) may be used interchangeably with “UE” (user equipment) in this disclosure. In certain embodiments, a WTRU may include more than one UE.

“Network” may include AMF (e.g., access and mobility management function), LMF (e.g., location management function), gNB (e.g., gNode-B), or NG-RAN (e.g., next generation radio access network) in this disclosure.

“Pre-configuration” and “configuration” may be used interchangeably in this disclosure.

“Non-serving gNB” and “neighboring gNB” may be used interchangeably in this disclosure.

“gNB” and “TRP” (e.g., transmission/reception point) may be used interchangeably in this disclosure.

“DL-RS” (e.g., downlink reference signal) or “DL-RS resource” may be used interchangeably in this disclosure.

“DL-RS(s)” or “DL-RS resource(s)” may be used interchangeably in this disclosure. Moreover, each of the “DL-RS(s)” or “DL-RS resource(s)” may belong to different DL-RS resource sets.

“Measurement gap” or “Measurement gap pattern” may be used interchangeably in this disclosure. For example, a “measurement gap pattern” may include parameters such as measurement gap duration or measurement gap repetition period or measurement gap periodicity.

An LMF is a non-limiting example of a node or entity (e.g., network node or entity) that may be used for or to support positioning or sensing. In certain embodiments, any other node or entity may be substituted for the LMF, while remaining consistent with this disclosure.

The UE may receive a preconfigured threshold(s) from the network (e.g., LMF, gNB).

The LOS (e.g., line-of-sight) indicator may be a hard indicator (e.g., 1 or 0) or a soft indicator (e.g., 0, 0.1, 0.2 . . . , 1). The LOS indicator indicates the likelihood of the presence of an LOS path between TRP and UE or along DL-RS. The LOS indicator can be associated with a TRP or PRS (e.g., positioning reference signal) resource ID (e.g., identification) (e.g., where the PRS resource ID may be a particular index). The UE may receive the LOS indicator from the network per TRP or resource ID. Alternatively, the UE may determine the LOS indicator per TRP or resource ID based on measurements.

“ID” and “index” may be used interchangeably in this disclosure.

A UE location may, for example, be expressed in terms of altitude, latitude, geographic coordinate, local coordinate, or any other suitable indicator of a location.

In certain examples described herein, a timestamp be indicated by absolute time, relative time (e.g., in seconds) compared to a reference time, SFN (e.g., single-frequency network), slot index, frame index, subframe index and/or symbol index. For example, “absolute time” may refer to UTC time, GNSS time, or locally defined absolute time (e.g., LTE or NR Time).

DL-RS (e.g., channel state information reference signal (CSI-RS), demodulation reference signal (DM-RS), tracking reference signal (TRS)) and single-sideband modulation (SSB) may be used interchangeably in this disclosure.

“Sensing” may be interchangeably used with “positioning”, “measurement” or “communication” in this disclosure.

“N” or “M” or “k” may be used in association with various aspects of this disclosure to indicate any suitable one or more integer values (e.g., corresponding to a number of measurement occasions or a particular measurement occasion).

“Uncertainty” may be interchangeably used with “confidence level,” “quality of measurement,” “accuracy level of measurement,” and “error level of measurement” in this disclosure.

“Measurement occasion” may be interchangeably used with “measurement instance” in this disclosure.

“Measurement range” may be interchangeably used with “measurement window”, and may be a subset of a “time window” as used in this disclosure.

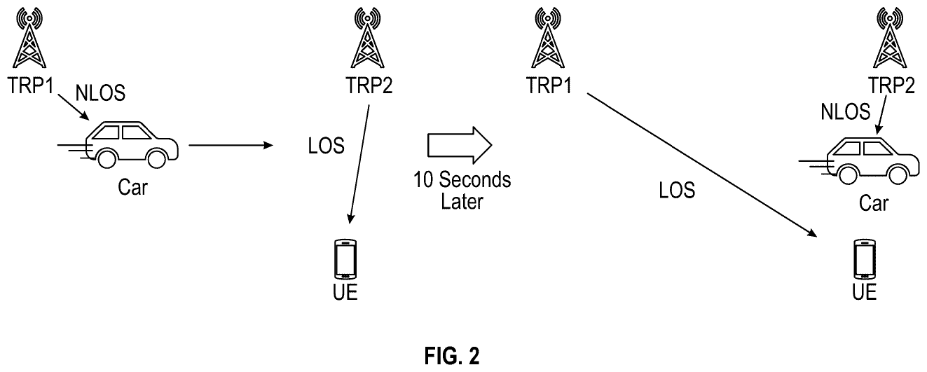

As provided below, FIGS. 2-20 may illustrate certain embodiments of using a WTRU or a UE for wireless object detection (e.g., including determining when to perform a sensing measurement and/or report the sensing measurement to a wireless network). FIGS. 2-20 may rely on any part or whole of the devices, systems, architectures, communication links, apparatuses, or other elements depicted in FIGS. 1A-1D.

FIG. 2 shows how a mobile object can block a line-of-sight (LOS) path between a transmission/reception point (TRP) (e.g., which may correspond to one or more of the illustrative wireless base stations 114a-b, one or more of the illustrative eNode-Bs 160a-c, one or more of the illustrative gNBs 180a-c, any other suitable wireless transmission/reception point, or any combination thereof) and user equipment (UE) (e.g., which may correspond to user equipment 102). Thus, the line-of-sight (LOS) or not-line-of-sight (NLOS) status of a the UE and TRPs can change when the target moves. Because the UE reports sensing-related measurements to the network during UE-assisted sensing, the UE may account for how and when a mobile object blocks this LOS.

A UE may send a request to a network for a configuration (e.g., DL-RS configurations, uplink reference signal (UL-RS) configurations) using a physical uplink shared channel (PUSCH), physical uplink control channel (PUCCH), uplink control information (UCI), medium access control-control element (MAC-CE), radio resource control (RRC) or LTE positioning protocol (LPP) message protocol. The request from the UE may include configurations of a measurement gap, DL-RS processing window or window for transmission of UL-RS. The UE may also send an acknowledgement message in PUSCH or PUCCH to recognize having received a message (e.g., a grant, permission, bandwidth, or other suitable message) received from the network.

In communication between the UE and the wireless network, any suitable combination of conditions/criteria can be transmitted. The UE may be configured based on one or more conditions and associated UE operations. Then, the UE may determine which operations the UE should use based on the applied conditions.

The UE can measure a DL from inside or outside of an active bandwidth part (BWP). The UE may likewise transmit UL-RS from inside or outside of an active BWP.

The UE may be preconfigured with parameters (e.g., measurement gaps, DL-RS processing windows, DL-RS configurations, UL-RS configurations, or any other suitable parameters) that can be sent via a semi-static message (e.g., LPP, RRC, or any other suitable protocol). Moreover, any actions that the UE determines to execute may be configured by the network. For example, the UE may be configured with a rule and according to the rule, the UE may determine to execute an associated action.

In addition to the measurements made on DL-RS, the UE may include at least one of the following cell-related measurements: SSB (single-sideband modulation) RSRP (reference signal received power) from the serving cell with corresponding cell ID; SSB RSRP from the neighboring cell(s) with corresponding cell ID(s); RSRP of CSI-RS with CSI-RS resource ID; or RSRS of DM-RS.

### Configurations for Reference Signals (RS)

In one example, the UE may receive DL-RS and/or UL-RS (e.g., SRS) configurations from the network for positioning purposes (e.g., LMF). The LMF may forward the PRS configuration and SRS configurations to the gNB so that the gNB can schedule PRS transmission or SRS reception at the TRP, TP and/or RP.

Some representative configurations for a DL-RS are described as follows. A DL-RS configuration may contain at least one of the following parameters: number of symbols, transmission power, number of DL-RS resources included in DL-RS resource set, muting pattern for DL-RS (e.g., with the muting pattern expressed via a bitmap), periodicity, type of DL-RS (e.g., periodic, semi-persistent, or aperiodic), slot offset for periodic transmission for DL-RS, vertical shift of DL-RS pattern in the frequency domain, time gap during repetition, repetition factor, RE (resource element) offset, comb pattern, comb size, spatial relation (e.g., with respect to other DL-RSs or UL RS such as SRS for positioning purpose), QCL information (e.g., QCL target, QCL source) for DL-RS, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for DL-RS transmission, on/off indicator for DL-RS, TRP ID, DL-RS ID, cell ID, global cell ID and applicable time window. In certain embodiments, the UE may apply a DL-RS configuration based on a condition that the current time is within the applicable time window.

Some representative examples of DL-RS include CSI-RS, phase tracking reference signal (PTRS), PRS, TRS, and SSB.

Some representative configurations for a UL-RS are described as follows. A UL-RS or SRS configuration may include at least one of: resource ID, comb offset values, cyclic shift values, start position in the frequency domain; number of UL-RS symbols, shift in the frequency domain for UL-RS, frequency hopping pattern, type of UL-RS (e.g., aperiodic, semi-persistent or periodic), sequence ID used to generate UL-RS, or other IDs used to generate UL-RS sequence, spatial relation information, indication of which reference signal (e.g., DL RS, UL RS, CSI-RS, SRS, DM-RS) or SSB (e.g., SSB ID, cell ID of the SSB) the UL-RS is related to spatially (e.g., where the UL-RS and DL RS may be aligned spatially), quasi-colocation (QCL) information (e.g., a QCL relationship between UL-RS and other reference signals or SSB), QCL type (e.g., QCL type A, QCL type B, QCL type C, QCL type D), resource set ID; list of UL-RS resources in the resource set, transmission power related information, pathloss reference information which may contain index for SSB, CSI-RS or DL-RS; periodicity of UL-RS transmission, and/or spatial information such as spatial direction information of UL-RS transmission (e.g., beam information, angles of transmission), spatial direction information of DL RS reception (e.g., beam ID used to receive DL RS, angle of arrival).

Some representative examples of UL-RS are sounding reference signal (SRS) and, in particular, SRS for positioning purposes.

Some representative positioning techniques are described as follows. Categories of UE positioning techniques are provided as follows.

A “DL positioning method” may refer to any positioning method that uses downlink reference signals such as PRS. For example, the UE may receive multiple reference signals from one or more TRPs and may measure DL reference signal timing difference (RSTD) and/or RSRP. Some examples of DL positioning methods are downlink angle of departure (DL-AoD) or downlink time difference of arrival (DL-TDOA) positioning.

A “UL positioning method” may refer to any positioning method that uses uplink reference signals such as SRS for positioning. The UE may transmit SRS to multiple RPs, and the RPs may measure the UL RTOA (relative time of arrival) and/or RSRP. Some examples of UL positioning methods are UL-TDOA or UL-AoA positioning.

A “DL & UL positioning method” may refer to any positioning method that uses both uplink and downlink reference signals for positioning. In one example, a UE transmits SRS to multiple TRPs, and a gNB measures a Rx-Tx time difference (e.g., which is calculated based on the time of arrival of DL RS (e.g., PRS)). The gNB can measure RSRP for the received SRS. The

UE can measure a Rx-Tx time difference for a PRS transmitted from multiple TRPs. The UE can measure RSRP for the received PRS. The Rx-TX difference and the RSRP measured at UE and gNB may be used to compute round trip time. Here, “UE Rx-Tx time difference” refers to the difference between arrival time of the reference signal transmitted by the TRP and transmission time of the reference signal transmitted from the UE. An example of DL & UL positioning method is round-trip time (RTT) or multi-RTT positioning.

Some representative details and examples related to channel impulse response and this response's association with RS configurations are described as follows. A channel impulse response is one example of a measurement that may be used in certain embodiments of this disclosure. A channel impulse response that includes N paths may be defined by the following equation

$$h ( t ) = {\sum }_{k = 1}^{N} {h}_{k} ( t ) δ ( t - {τ}_{k} )$$

where hₖ(t) and τₖ are time-varying complex-valued coefficients (e.g., expressed by a+bj where j=\sqrt{−1} for the channel impulse response and delay) that may be measured in seconds and measured respectively for each k^{th} path. The delta function is defined as δ(t)=1 for t=0 and δ(t)=0 for t≠0.

In certain embodiments, we assume the coefficients are constant over time, e.g., hₖ(t)=hₖ. The UE may report hₖ and τₖ for each path k to the network. The UE may report the number of paths, N, to the network. Alternatively, the UE may receive hₖ and τₖ for each path k from the network and/or the number of paths.

In another example, the UE may obtain a CIR (Channel Impulse Response) from the network. The network may indicate a DL-RS configuration(s), e.g., DL-RS resource IDs associated with the CIR. In certain embodiments, the CIR may be associated with one or more DL-RS resource IDs. In such embodiments, the UE may determine that the CIR is derived based on the measurements made on the DL-RS resource associated with the ID; alternatively, the UE may determine that the channel along the direction of transmission of the DL-RS or the reception of the DL-RS corresponds to the CIR.

In another example, the CIR may be associated with a TRP ID. In such embodiments, the UE may determine that the CIR represents the channel between the associated TRP and the UE. In another example, the CIR may be associated with multiple TRPs, and the network may include or otherwise provide TRP indices that are associated with the CIR.

In another example, the CIR may be associated with one or more cells. In such embodiments, the UE may receive one or more cell IDs or indices that are associated with the CIR from the network.

In another example, the CIR may be associated with more than one TRPs or DL-RS resource IDs. In such embodiments, the UE may determine that the channel between the TRPs and the UE corresponds to the CIR. Alternatively, the UE may determine that the channel along the transmission directions of DL-RSs associated with IDs or reception directions of the DL-RS correspond to the CIR.

In another example, one or more CIRs may be associated with one or more parameters from DL-RS configurations (e.g., TRP ID, DL-RS resource ID, frequency layer ID). In certain embodiments, the UE may receive information related to two CIRs associated with a TRP from the network, e.g., the UE may receive

$${h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} )$$

from the network; alternatively, the UE may report information related to more than one CIRs associated with DL-RS configuration (e.g., TRP ID, DL-RS resource ID) based on the measurements to the network. There can be one or more CIRs associated with a DL-RS configuration because the UE or network may observe different channel characteristics based on, for example, the AoA (angle of arrival) or any other suitable property of the DL RS or the UL RS.

A channel impulse response may be represented by a DP (delay profile) or a PDP (power delay profile). A PDP may be defined as a set of delays and power profiles, such as [τ₀, τ₁, . . . , τ_{N-1}] and [p₀, p₁, . . . , p_{N-1}], respectively, where each power profile pk may correspond to a relative power at the k^{th} path (e.g., compared to the first path). A delay profile may be defined as a set of delays [τ₀, τ₁, . . . , τ_{N-1}] which indicates the path delay for each path above a threshold power profile p_{threshold}. The UE may receive a p_{threshold} value from the network to derive one or more DPs from one or more PDPs.

In one example, the UE may receive an indication from the network on how to generate a CIR, PDP or DP based on timing, phase and/or power measurements. For example, the UE may send a request to the network to receive an indication, based on which one or more methodologies may be used by the UE to generate CIR, PDP or DP based on UE measurements. For example, the UE may receive a message from the network (e.g., via LPP, RRC, MAC-CE, DCI) indicating the DL-RS resource indices and associated measurement type(s) (e.g., RSTD, AOA) to use to generate the CIR, PDP or DP. In another example, the UE may receive an indication from the network indicating to generate CIR, PDP or DP.

In one example, the UE may receive a threshold (e.g., power threshold) from the network and a timing range (e.g., 0 μs to 1 μs) and/or timing granularity (e.g., every 0.1 μs in the indicated timing range, 100 sample points in the indicated timing range) of the CIR, PDP and/or DP. In such embodiments, the UE may determine to report power and timing (e.g., relative timing compared to a reference timing, absolute timing) information for any measured samples with a received power that is over the threshold.

During object detection using a UE and a wireless network, a moving mobile object can disrupt the communication link between the UE and the wireless network. Moreover, the UE may need to report any changes to the environment that occur due to the moving object. Certain embodiments of this disclosure describe how the UE can measure and report changes in the environment to the network under such conditions.

In accordance with some embodiments of this disclosure, approaches for detection of a moving object are provided. In certain embodiments, the UE receives from the network (e.g., gNB) a condition (e.g., duration of measurement) for determination of a reference multipath measurement, an indication of the DL signal to be used as the reference (e.g., reference DL-RS ID), and a time range associated with the multipath measurement. Based at least in part on this information, the UE determines to report a measurement time instance within the time range if the difference in measurement quality (e.g., RSRP) at the time instance is, compared to the previously reported occasion, above a threshold.

A high-level summary which is representative of certain embodiments of methods, architectures, apparatuses, and/or systems provided in this disclosure for the detection of moving objects is described as follows. The UE receives DL-RS configurations from the network for periodic measurements. The UE also receives a condition to determine the reference measurement. The UE also receives trigger conditions for measurement reporting from the network. If the trigger condition at a measurement time instance is satisfied, then the UE reports the measurement to the network. The UE terminates the periodic measurement when an exit condition is met (e.g., timer expiry).

In certain embodiments, the UE receives from the network (e.g., gNB) a condition (e.g., duration of measurement) for determination of a reference multipath measurement, an indication of the DL signal to be used as the reference (e.g., reference DL-RS ID), and a time range associated with the multipath measurement. The UE determines to report a measurement time instance within the time range if, compared to the previously reported occasion, the difference in measurement quality (e.g., RSRP) recorded at the time instance is above a threshold.

In certain embodiments, the UE executes the following actions. The UE configures measurement equipment for receiving periodic DL-RSs (e.g., periodicity, DL-RS resource IDs) to make sensing measurements. The UE configures periodically occurring time windows (e.g., monitoring window) during which the UE makes measurements on the DL-RSs. The UE may also configure a maximum number of measurement instances (N) to be included in the report. The UE receives an indication from the network, the indication including at least one of a measurement granularity, power threshold, requested measurement range, or maximum number of measurements per report. If the UE doesn't receive the requested measurement range from the network, then the UE makes measurements on the configured maximum range. If the UE does not receive the power threshold, then the UE reports RSRP at each sample in the determined range. If, compared to a prior reporting occasion, the difference in RSRP of the sample measured over the DL-RS during the indicated measurement range exceeds the power threshold, then the UE includes the RSRP and corresponding relative sample time in the reference time measurement report. The UE may also include N measurement instances in the report. The UE reports measurements made during a configured time window to the network.

According to certain embodiments of this disclosure, measurement configurations and procedures for requesting to detect a mobile object and for responding based on the sensing operation are provided as follows.

In one example, the UE may receive, from the network (e.g., gNB, LMF), configurations indicative of the DL-RS (Downlink Reference Signals) from which the UE may make measurements (e.g., related to the target object). For example, the UE may determine to make measurements for the purpose of sensing. In certain embodiments, the UE may be configured to make measurements on the indicated DL-RSs and report types of measurements described herein to the network.

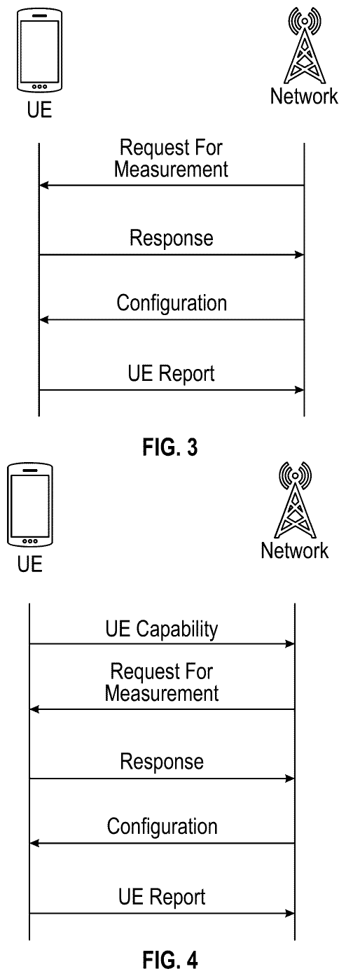

FIG. 3 shows illustrative interactions between the network and the UE for initiating sensing. In certain embodiments, the UE may determine to make measurements on the DL-RS for sensing purposes, and FIG. 3 shows a corresponding communication flow diagram between the UE and a network. In the example of FIG. 3, the UE receives, from the network, a request for sensing or making measurements on DL-RSs that are indicated in the request for measurement. The UE may receive the request as broadcast, multi-cast or unicast of a higher layer message (e.g., LPP, RRC), as MAC-CE, or as a lower-layer message (e.g., DCI). Continuing this description of the example of FIG. 3, the UE then sends a response (e.g., ACK, NACK, accepting or denying the request, UE capability) to the network. If the UE determines to accept the request, then the UE may receive configurations of DL-RSs from the network. The UE may determine to make a measurement report, and may subsequently provide this UE report to the network, if one or more trigger conditions associated with the measurement reporting are met or satisfied.

According to certain embodiments of this disclosure, descriptions of UE sensing capabilities are provided as follows.

FIG. 4 shows illustrative interactions between the network and the UE for obtaining one or more DL-RS configurations for sensing. In the example of FIG. 4, the UE may determine to send a UE capability report to the network based on a request from the network or as part of an initial access procedure. The UE capability report may include at least one of the following: capability to make measurements based on receiving specific types of DL-RSs (e.g., SSB, CSI-RS, DM-RS, PRS, TRS, PTRS); capability to make measurements periodically, e.g., with a corresponding periodicity (e.g., 1 ms); capability to report to the network periodically, e.g., with a corresponding periodicity (e.g., 1 ms); capability to perform measurements and send reports that contain the measurements; capability to perform sensing-related measurements and send reports that contain the sensing related measurements; capability to perform sensing and communication (e.g., ISAC); capability to use UE location information and a corresponding method to determine the UE location information (e.g., based on global navigation satellite system (GNSS), or radio access technology (RAT) dependent position); or one or more supported sensing type, which may include one or more of: sensing accuracy (e.g., maximum or minimum accuracy, measurement granularity), measurement use case (e.g., detection, tracking, etc.), sensing measurement with/without UE positioning information, number of sensing measurement resources UE can perform simultaneously, or simultaneous sensing measurements with simultaneous communication, at the same and/or different frequencies.

After sending the UE capability report, the UE may receive a request for sensing from the network. The UE may send a response to the request to the network. If the response indicates that the UE accepts the request, then the UE may receive configurations indicating how to performance measurements on incoming DL-RS. The configuration may include one or more trigger conditions, where the UE may determine to make measurements and provide corresponding measurement reports if the one or more trigger conditions are satisfied.

According to certain embodiments of this disclosure, characteristics of DL-RS (e.g., based on which sensing measurements are made) are provided as follows.

The UE may receive configurations of the DL-RS from the network via broadcast, multi-cast or unicast communications. The configurations of the DL-RS may include the parameters for reference signals as further described throughout this disclosure. For example, the parameters can include one or more of the periodicity of the DL-RS, frequency information (e.g., absolute radio frequency channel number (ARFCN), frequency range, range of frequency), sequence information of the DL-RS (e.g., scrambling ID), transmission power level, and time/frequency pattern/density of the DL-RS.

In one example, the range of frequency may be expressed in terms of BWP (bandwidth parts), a lower and/or higher frequency value (e.g., in terms of Hertz), a number (e.g., resource block identifier or number, resource element number or identifier), an indicator (e.g., indicator associated with a range of frequency resources), or any combination thereof.

In one example, the UE may be configured with the time-domain parameters of the DL-RSs. For example, the UE may be configured with the number of slots, symbols or frames that contain the DL-RSs based on which the UE makes measurements.

In another example, the UE may receive an indication for a search space of the DL-RSs. For example, the UE may be configured with time and frequency resources that the UE determines to monitor to detect the potential presence of the DL-RS. If the UE determines that the DL-RS exists in the indicated time and frequency resources, then the UE may determine to make measurements on the DL-RS. These aforementioned time and frequency resources may be provided periodically or semi-persistently (e.g., the resources may be periodic during a time window, may be periodically-occurring time and frequency resources, and/or may be activated/deactivated by MAC-CE communications).

In another example, the UE may receive a request to receive and decode a downlink channel (e.g., PDCCH, PDSCH) and may thus determine the location of the DL-RS to measure. The downlink channel may contain information about the time and frequency resources of the DL-RS based on which the UE is configured to make measurements.

In another example, the UE may determine a sequence of the DL-RS for a sensing measurement. The sequence may be determined based on at least one of a sensing use case (e.g., detection, tracking), a geographical location of the target (or the UE), a required sensing measurement accuracy level, a physical cell ID (or TRP ID) associated for the sensing, or the UE-ID. In certain embodiments, the sequence described herein includes one or more of a sequence type (Gold-sequence, m-sequence, Zadoff-Chu, etc.), sequence initialization ID, scrambling ID, cyclic shift index, or a root-index. Any one or more of these parameters may be used (e.g., by the UE and/or the network) to determine the sequence.

According to certain embodiments of this disclosure, content of the UE request is provided as follows.

The UE may receive a request (e.g., received in a semi-static message such as RRC, LPP) from the network to make measurements on DL-RS. The request or configurations for measurements may contain at least one of the following types of information: whether the measurement should be made once (e.g., aperiodic), periodically or semi-persistently; periodicity of DL-RS; periodicity of measurements; number of occasions to make measurements; start and/or end time of transmission of DL-RS (e.g., expressed in terms of SFN, frame index, sub-frame index, slot index, symbol index, absolute time, relative time with respect to a reference); duration of measurement (e.g., expressed in terms of number of frames, sub-frames, slots, symbols); or required measurement quantities (e.g., the measurement quantities may be reported as an outcome of the measurement, e.g., based on measurement qualities including phase, power, timing and angle measurements, or any combination thereof).

According to certain embodiments of this disclosure, descriptions of the monitoring window of the UE are provided as follows.

The UE may receive, from the network, configurations for the monitoring window. Within a monitoring window, the UE may make measurements on the received DL-RS. The configuration parameters for a monitoring window may include a periodicity (e.g., expressed in terms of number of frames, sub-frames, slots, symbols, time), duration (e.g., expressed in terms of number of frames, sub-frames, slots, symbols, absolute time), start and/or end time associated with the monitoring windows, or any combination thereof.

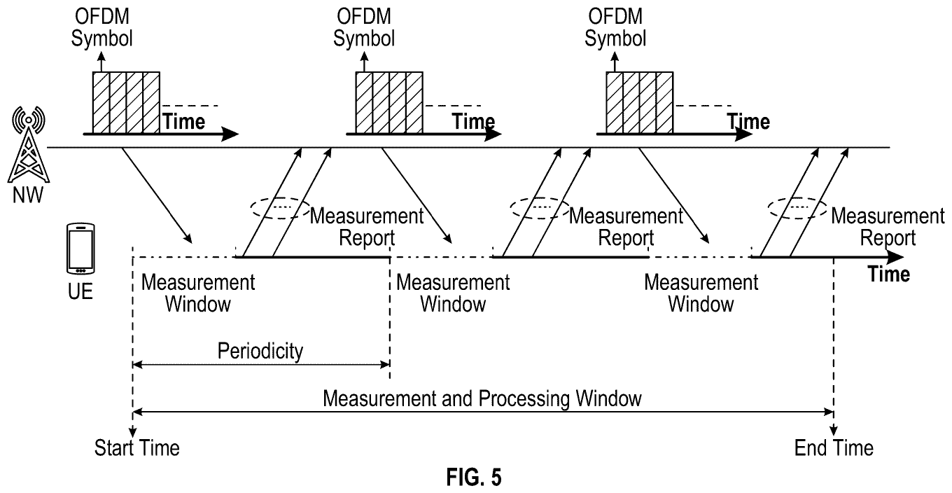

FIG. 5 shows illustrative configurations of monitoring windows. In the example of FIG. 5, the UE receives and makes measurements on the received DL-RS during the periodically occurring window. The UE may be configured with periodically occurring windows that are temporally arranged according to the indicated start and end times. In the example of FIG. 5, the duration between the aforementioned start and ends time is indicted as the “measurement and processing window”. After measurements, the UE may determine to report the corresponding measurements to the network.

In one example, the motioning period may be defined by the duration indicated by the start and end time. In another example, the UE may receive an indication to start a timer when monitoring starts, and the UE may further receive an indication of how long the timer should run before ending the monitoring period.

According to certain embodiments of this disclosure, descriptions of the reference measurement of the UE are provided as follows.

The UE may receive an indication or configuration for the reference DL-RS to be used to make a reference measurement. The reference measurement may be used by the UE to determine whether to report the measurements to the network or not based on the difference between the current and reference measurement. The UE may receive any suitable type of information for determining the reference DL-RS; some representative examples of suitable types of information are provided as follows.

The UE may receive DL-RS configuration (e.g., DL-RS resource ID, DL-RS resource set ID). For example, the UE may receive a DL-RS resource ID from the network to be used as the reference. The UE may make measurements on one or more particular DL-RSs, indicated by the DL-RS resource IDs, to generate sensing measurements and/or reference measurements.

The UE may receive the number of measurement samples needed to make measurements. A measurement sample may be set based on a measurement the UE made on a measurement occasion. A measurement occasion may be a set of DL-RS symbols (e.g., the number of symbols indicated by a DL-RS resource, or the number of DL-RS symbols in a slot). In another example, one measurement occasion may correspond to the measurements made in one monitoring window. For example, as shown in FIG. 5, there are three windows and therefore the UE may generate three measurement samples. The UE may determine to aggregate more than one of these measurement samples to determine the reference measurement. For example, if the indicated number of measurement samples is N=4, then the UE may aggregate the measurements made over four sets of DL-RS symbols and thereby determine the reference measurement. The UE may also determine to calculate an average of the aggregated measurement (e.g., an average of the RSRP, ToA (time of arrival), or any other suitable metric).

The UE may receive a measurement threshold (e.g., RSRP, LOS indicator). For example, the UE may determine to use DL-RS as the reference signal when the UE measurement (e.g., RSRP of the received DL-RS) is over the configured measurement threshold. In another example, the UE may determine to use the DL-RS as the reference when the channel impulse response (e.g., CIR, PDP, DP) obtained from the DL-RS has a first path RSRP that is greater than the threshold. In another example, the UE may determine to use the measurement as the reference when the associated LOS indicator is above the threshold. In another example, the UE may be configured to use the DL-RS as the reference if a measurement (e.g., RSRP) associated with the DL-RS is greater than the threshold for N consecutive occasions (e.g., N measurement occasions, N slots, N frames, N subframe, N symbols).

The UE may receive a spatial Tx or Rx direction. For example, the UE may be configured with a first DL-RS resource (e.g., SSB #1) that contains spatial information which can be used to determine the direction of measurement. The UE may be configured with more than one DL-RS resources. The UE may determine to make measurements on DL-RSs when the spatial information is aligned with the first DL-RS (e.g., the UE may determine to make measurements on DL-RSs that are spatially aligned with SSB #1).

In another example, the UE may determine its own reference. In such embodiments, the UE may report the DL-RS configuration (e.g., DL-RS resource ID) that the UE used as the reference. For example, the UE may determine to choose its own reference when the UE does not receive, from the network, the configurations related to the reference DL-RS.

According to certain embodiments of this disclosure, descriptions of the UE receiving assistance information about the reference are provided as follows.

The UE may receive assistance information related to reference measurement or timing from the network. In another example, the UE may receive the reference measurement from the network. The reference measurement may include any one or more of the following: relative time of arrival of each path, where each path may have a respective delay with respect to the reference path (e.g., first path, LOS path); Doppler shift per path, Doppler spread per path, Doppler shift or Doppler spread for the measurement; AoA per path; phase measurement (e.g., actual phase measurement, phase difference measurement compared to a reference) per path; or number of paths.

The aforementioned quantities associated with a reference measurement may be expected values or they may be actual values. These reference measurements may be associated with a DL-RS configuration parameter (e.g., DL-RS resource ID, TRP ID, etc.).

In one example, the UE may receive a reference measurement instance from the network. For example, the UE may receive a time reference (e.g., absolute time, relative time, indication of the timestamp reported by the UE, indication of the measurement report index, path index, associated DL-RS configuration) from the network. The UE may determine to report a change in the measurement as compared to the measurement made or reported at the reference time.

According to certain embodiments of this disclosure, descriptions of the measurement start conditions are provided as follows.

In one example, the UE may start monitoring or making measurements on the configured DL-RS when the UE receives an indication from the network. The UE may determine to start making measurements at the configured time offset (e.g., N slots, frames, sub-frames, symbols), where ethe offset is respect to when the UE receives the indication from the network to start monitoring or making measurements. In another example, the UE may start making measurements on the configured DL-RSs during one or more time windows configured by the network.

When the configured DL-RS is not monitored/measured by a UE (e.g., before reception of the network indication to start monitoring/make measurements), the resources for the configured DL-RS may be used for data transmission (e.g., no PDSCH rate-matching may occur around when the scheduled PDSCH interferes or overlaps with the configured DL-RS); otherwise, the UE may perform rate matching around the PDSCH REs that interferes or overlaps with the configured DL-RS during a scheduled monitoring/measurement time.

According to certain embodiments of this disclosure, descriptions of the measurement exit (or measurement stop, or measurement termination) conditions are provided as follows.

In one example, the UE may determine to terminate making measurements (e.g., in response to determining that an exit condition has occurred) on the received DL-RS after any one or more of the following conditions are satisfied: the UE reaches the stop time of the monitoring period; the UE receives an explicit indication from the network to terminate the monitoring or terminate the making of measurements on the configured DL-RS; the timer associated with the measurement and processing window expires; the number of measurement occasions or measurement reporting occasions reaches the configured number of measurements or reports; the number of measurement occasions reaches a threshold (e.g., that may be predefined, configured by the UE, or indicated along with a measurement start indication from the network) without the occurrence of consecutively triggered measurement reporting; the battery remaining level of the UE is below a threshold; the temperature (e.g., overheating level) of the UE is above a threshold; the signal strength (e.g., RSRP) of the configured DL-RS is below a threshold; or the location of the UE changes by more than a threshold amount (e.g., the UE is outside of the sensing area, or the UE is outside of the configured validity area in which the UE may determine its location based on RAT dependent (e.g., DL-TDOA) or independent (e.g., GNSS) positioning methods).

According to certain embodiments of this disclosure, descriptions of DL-RS configurations for Doppler frequency estimation are provided as follows.

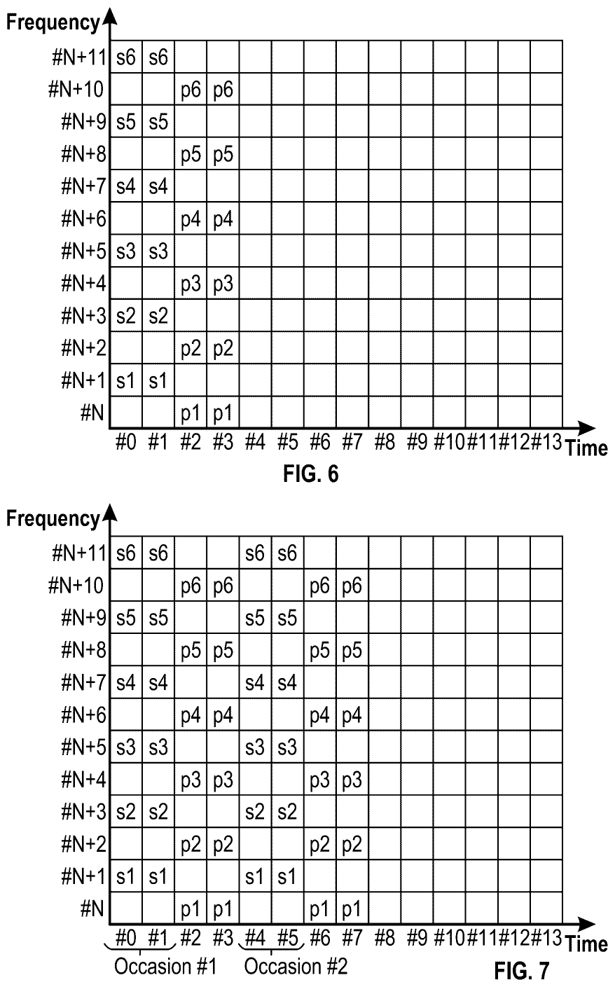

FIG. 6 shows an illustrative DL-RS configuration that the UE may receive. As shown in the example of FIG. 6, the UE may receive DL-RS configurations indicating that the same DL-RS sequence may be used for N consecutive symbols. Further to the example of FIG. 6, time frequency resources occupying 12 OFDM symbols and 12 resource elements (or subcarriers) are shown. In FIG. 6, symbol #0 and symbol #1 carry the same sequence. In this DL-RS sequence, s₁, s₂, s₃, s₄, s₅, s₆, are located at the resource element #(N+1), #(N+3), #(N+5), #(N+7), #(N+9) and #(N+11), where N is an integer. Each element in the sequence can be represented by sᵢ=aᵢ+jbᵢ, where aᵢ and bᵢ are real and imaginary components and j=\sqrt{−1}. In FIG. 6, symbol #2 and symbol #3 carry the same sequence. In this DL-RS sequence, p₁, p₂, p₃, p₄, p₅, p₆, are located at the resource element #N, #(N+2), #(N+4), #(N+6), #(N+8) and #(N+10).

In another example, the UE may receive a configuration for the number of repetitions of OFDM symbols that are provided with the same sequence for a RS. For example, referring again to FIG. 6, the number of repetitions of RS (e.g., with the same sequence) is two. One or more different RS sequences may be associated with respective DL-RS resource IDs. For example, the sequence sᵢ may be associated with a DL-RS resource ID #1 while the sequence pᵢ may be associated with a DL-RS resource ID #2.

FIG. 7 shows an illustrative periodicity value received by the UE for a DL-RS. Consistent with the example shown in FIG. 7, the DL-RSs may be repeated within a slot (as shown in FIG. 7) or it may be repeated across respective slots. In FIG. 7, two occasions (namely, Occasion #1 and Occasion #2) of periodic DL-RSs are shown.

According to certain embodiments of this disclosure, measurement descriptions and descriptions of the measurement range conditions are provided as follows.

In one example, the UE may be configured with a time range of measurements. For example, the time range may be expressed in terms of seconds. Lower and upper bounds of timing measurements that are made by the UE on the indicated DL-RS resource may be within the configured time range. One illustrative example of a time range may be [0, 4] μs, 0 μs and 4 μs are the lower and upper bounds of the range, respectively.

In another example, the UE may receive a configuration (e.g., may be requested by the network) to make measurements during the CP (cyclic prefix) time window. In such embodiments, the corresponding time range may be [0, CP_LENGTH], where CP_LENGTH is the duration of the CP. In certain embodiments, a time window is an entire cyclic prefix, and a measurement range is a subset of the entire cyclic prefix.

In another example, the measurement range may be defined or configured based on the OFDM symbol length (L_{OFDM,SYM}). For example, the OFDM symbol length may be determined based on the subcarrier spacing of the OFDM waveform. In an example, the measurement range may be configured as [0, L_{OFDM,SYM}/M], where M may be any positive integer. In another example, the measurement range may be any suitable subset of the OFDM symbol length and the measurement range may be shifted such that a lower bound of the measurement range occurs after a reference time 0 or T0.

According to certain embodiments of this disclosure, descriptions of the types of measurements and measurement quantities are provided as follows.

In particular, descriptions of the time measurement and the received power of the indicated DL-RS are provided as follows.

In one example, timing measurements may be described by the ToA of the indicated DL-RS with respect to the first DL-RS that arrives at the UE. The UE may also be configured with a power threshold. In such embodiments, the UE may report power measurements for the indicated DL-RS if the corresponding power measurement is over the power threshold.

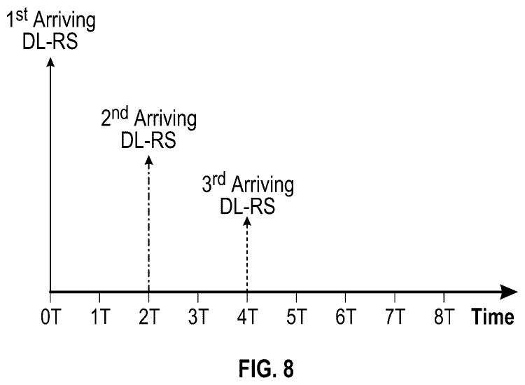

FIG. 8 shows an illustrative example of a single DL-RS arriving multiple times at the UE. In FIG. 8, the 1^{st} arriving DL-RS first is observed at the reference time instance (e.g., 0T, where T is a configured granularity of measurement; e.g., as expressed in terms of seconds). The same DL-RS transmission may also arrive later (e.g., after 0T) due to the transmitted signal reflecting against environmental objects (e.g., buildings, cars, or other objects). Illustrative examples of late-arriving DL-RSs are also shown in FIG. 8; in particular, the 2^{nd} and 3^{rd} arriving DL-RS are measured at time instances 2T and 4T, respectively (where 2T and 4T are defined with respect to the reference time 0T). In one example, the UE may be configured to report relative ToA of one or more of the DL-RSs that are received after the 1^{st} arriving DL-RS. In the illustrative example shown in FIG. 8, the UE may report [2T, 4T] when configured to perform sensing over the measurement time range [0T, 8T].

In certain embodiments, the 1^{st} arriving DL-RS may be referred to as the “1^{st} path”. Similarly, the nth arriving DL-RS may be referred to as the “nth path”.

In one example, the reference time may any one or more of the following: ToA of the 1^{st} path; initialization time of the first subframe, SFN, DFN, first frame, and/or first slot; reference time the UE determines prior to making measurements (e.g., referent time obtained from GPS, GNSS); or reference time configured by the network.

In one example, the UE may be provided with expected ToAs. These expected ToAs may be defined with respect to the 1^{st} arriving DL-RS ToA. The one or more expected ToAs may be used by the UE to determine the actual ToA for the DL-RS.

The UE may report the ToA based on a measurement threshold. For example, the UE may be configured with a power threshold (e.g., expressed in terms of dBm, dB with respect to a reference) and the UE may determine to report the RSRP and the relative ToA when the RSRP is above the power threshold.

In one example, the power threshold may be determined based on one or more UE receiver capabilities. A UE receiver with a higher sensitivity may have a lower power threshold, or vice-versa. For example, the UE may be configured before a sensing operation, or it may be preconfigured, with one or more power thresholds, and based on the UE receiver's sensitivity level, the UE may determine which power threshold to use. In other embodiments, a UE may report receiver sensitivity level as a part of the sensing capability to the network, and the network may accordingly configure a power threshold value for the UE to use when determining whether or not to perform a measurement reporting.

According to certain embodiments of this disclosure, descriptions of a timing measurement with respect to the ToA of another RL-DS are provided as follows.

The UE may be configured to report a received signal time difference between respective DL-RSs, namely with respect to a present time DL-RS and a reference RS (e.g., which is associated with a reference time, e.g., based on when the reference RS is received at the UE). The UE may be configured as such based on receiving configuration parameters related to the reference RS (e.g., DL-RS resource ID).

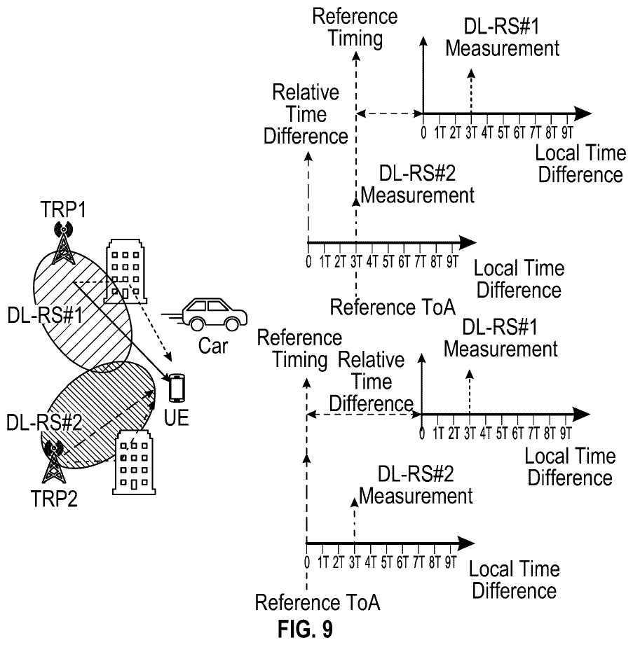

FIG. 9 shows illustrative UE reference signal timing configurations. In certain embodiments, the UE may determine the ToA for DL-RS #1 with respect to the ToA of the reference signal, DL-RS #2. In certain embodiments, a single reference signal may be associated with more than one path (e.g., as shown in FIG. 9, DL-RS #1 travels along a first path that is directly to the UE and a second path that reflects off a first building, and DL-RS #2 travels along a third path that is directly to the UE and a fourth path that reflects off a second building). In such embodiments, the reference time may be the ToA of the initially-arriving path (e.g., the aforementioned first path or third path described in connection with FIG. 9) or the ToA of the subsequently-arriving path (e.g., the aforementioned second path or fourth path described in connection with FIG. 9).

According to certain embodiments of this disclosure, descriptions of reporting a reference signal's or a received signal's envelope power are provided as follows.

In certain embodiments, the UE may be configured to report the received signal's power as is observed during the measurement range. In such embodiments, the UE may report envelope power, peak envelope power, any other suitable received power, or any combination thereof. Moreover, the UE may be configured with a power threshold. Thus, the UE may report any power measurement (e.g., average of RSRP per path over the measurement range, envelop power during the measurement range) that is determined by the UE to be over the power threshold. In certain embodiments, the UE (e.g., during a configuration of the UE) may not receive information about specific DL-RSs on which to make measurements. In such embodiments, the UE may indicate in one or more reports to the wireless network the received power of any received signals.

According to certain embodiments of this disclosure, descriptions for how the UE performs a power measurement on a reference signal are provided as follows.

In certain embodiments, upon each arrival of a DL-RS, the UE may be configured to report a corresponding power measurement to the network. In one example, for each arriving DL-RS the UE may report average RSRP measured over the configured bandwidth of the DL-RS. In another example, the UE may report RSRP per unit (e.g., sub-block, RBs, a group of RBs) in the frequency domain for each arriving DL-RS. The UE may determine to report the RSRP per unit (e.g., sub-block, RBs, a group of RBs) by aggregating measurements from multiple DL-RSs that arrived within the time range. In another example, the UE may receive a request from the network and in response may report the RSRP per unit in the time domain (e.g., path, sample, instance).

According to certain embodiments of this disclosure, descriptions for how the UE performs an angle measurement on a reference signal are provided as follows.

In certain embodiments, the UE may be configured to make angle measurements (e.g., AoA or other suitable angle measurements). The UE may, for example, report these angles in radians or degrees. The UE may be configured to make an angle measurement for each arriving DL-RS. For example, returning to the illustrative depiction of FIG. 8, the UE may report [0, 20, 30] degrees for three angle measurements performed on the DL-RSs, with these three angle measurements respectively corresponding to the three DL-RSs arriving at 0T, 2T and 4T.

AoA measurements performed by the UE may provide relative or absolute angles. The relative AoA may be defined with respect to the AoA of the reference. In one example, the UE may be configured with a reference based on the AoA of the 1^{st} arriving DL-RS. In another example, the UE may be configured with a reference angle based on a different DL-RS (e.g., SSB) that the UE is monitoring. In another example, the reference may be a location of a TRP that is indicated by the network (e.g., in a configuration of the UE). The location of TPR may, for example, be expressed in terms of an absolute location with geographical coordinates expressed by x and y coordinates, or a relative location with respect to a reference point (e.g., where the reference point may be a particular TRP specified in a configuration or indication, a cell center, a location of a known object, or any other suitable reference location).

In certain embodiments, the UE may perform angle measurements with respect to an absolute angle. The absolute angle may be defined with respect to a global reference, e.g., geographical north or any other suitable cardinal direction.

In one example, the UE may be configured with an expected AoA. For example, the UE may be configured to associate an expected AoA with each DL-RS (where multiple DL-RSs may or may not have distinct expected AoAs). In certain embodiments, the UE is provided or configured with expected ToAs, and the UE is further provided or configured with a respective expected AoA corresponding to each respective expected ToA (where the respective AoAs may or may not be distinct from each other).

According to certain embodiments of this disclosure, descriptions for how the UE performs a phase measurement on a reference signal are provided as follows.

In certain embodiments, the UE may be configured to make phase measurements. The UE may report a phase measurement for each DL-RS arriving at the UE. The UE may, for example, report the information phase in degrees or radians. The UE may calculate and report a differential phase that with respect to a reference phase. For example, the reference phase may be the phase value measured at the 1^{st} arriving DL-RS.

In certain embodiments, the UE may be configured to report phase offset or phase drift. For example, the UE may report the phase drift observed during the measurement window or measurement and processing window where the aforementioned parameters may be received according to the illustrative depictions of FIG. 5.

According to certain embodiments of this disclosure, descriptions for how the UE performs Doppler measurements are provided as follows.

The UE may be configured by the network or may receive a request from the network to report a Doppler frequency, Doppler spread and/or Doppler shift (which may collectively be referred to as Doppler information) based on the measurements made during the measurement window or the measurement and processing window. For example, the UE may be configured to report Doppler information per time instance and/or Doppler information per path. Moreover, the UE may determine to report time information (e.g., one or more time instances) that is associated with Doppler information.

In another example, the UE may determine to report Doppler information at a time instance if any one or more of the following conditions is satisfied: RSRP measured at the time instance is greater than a threshold RSRP for N consecutive measurement occasions; or RSRP measured during the measurement window is greater than a threshold RSRP for N consecutive measurement occasions.

In certain embodiments, the UE may determine to report Doppler information for a reflection (e.g., a transmission path with a reflection) that corresponds to a mobile object. For example, if the reflection appears for certain duration of time (e.g., RSRP at a time instance or a particular path is greater than the power threshold for N consecutive measurement occasions and measured power falls below the threshold after N measurement occasions), the UE may determine to report Doppler information for the reflection.

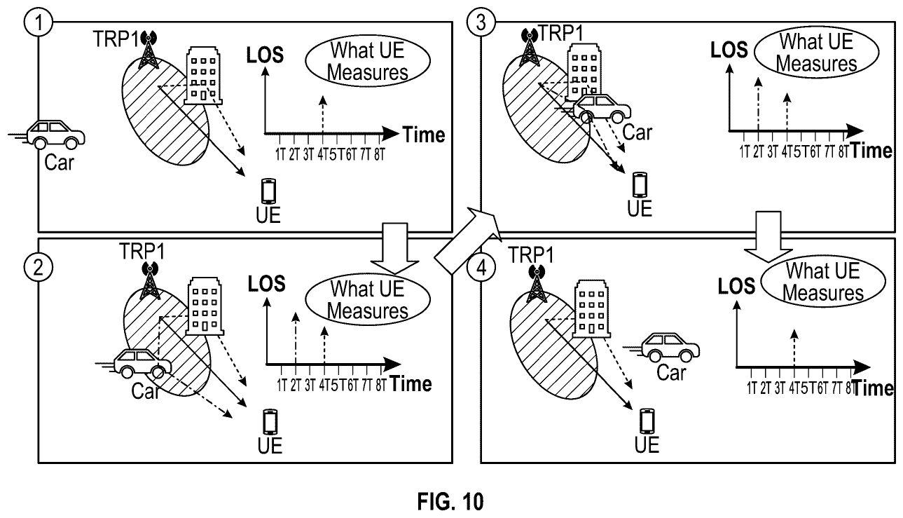

The UE may be configured (e.g., based on a request, indication, or instruction from the network) to buffer or accumulate measurements before the UE determines Doppler information associated with these measurements and/or subsequent measurements. The UE may be configured to make measurements that provide Doppler information after M measurement occasions (e.g., M repetition occasions, M occasions of measurements, M slots, M frames, M subframes, M symbols). FIG. 10 shows an illustrative event for which the UE reports Doppler information (e.g., Doppler shift). In the example of FIG. 10, the UE measures an incoming signal that was not reflected off an object (e.g., at time instance 0T, corresponding to the LOS signal); then measures, in certain instances as shown in panels 2 and 3 (e.g., corresponding to two consecutive measurement occasions), the same transmission as reflected off of a car (e.g., at time instance 2T); and then measures, the same transmission as reflected off of a building (e.g., at time instance 4T). Because the car enters and then exits the LOS path between TRP1 and the UE, the reflection at time instance 2T only is observed at measurement occasions 2 and 3. In certain embodiments, based on at least two measurement occasions (e.g., at least two of the illustrative measurement occasions 1-4 as shown in FIG. 10), the UE may determine to measure Doppler information associated with the time instance corresponding to the reflection off of the car (e.g., based on the signals received at time instance 2T).

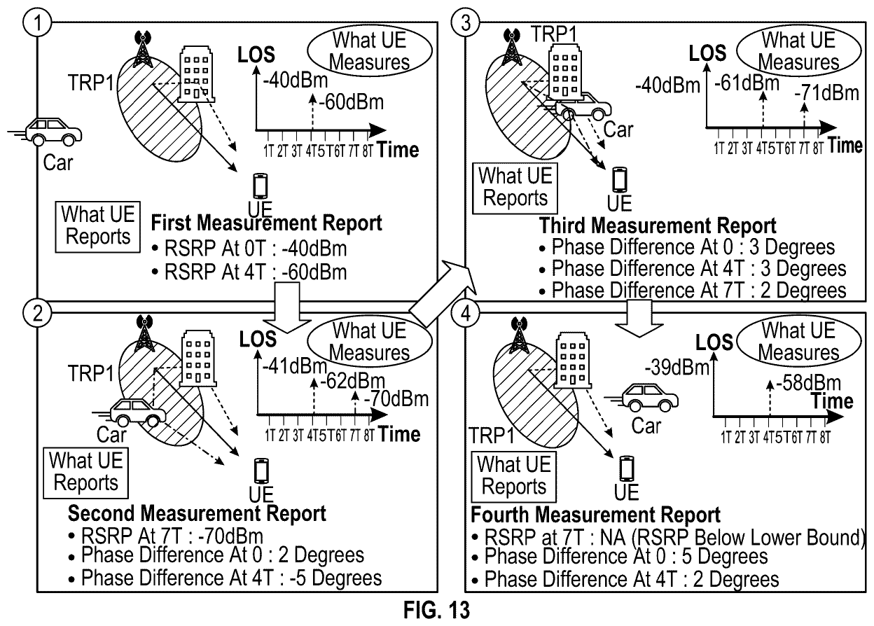

In certain embodiments, a Doppler frequency measurement may be based on a multipath signal. In one example, the UE may receive a request from the network to report an estimated Doppler frequency, Doppler spread and/or carrier phase offset. The UE may be configured with a corresponding DL-RS to estimate the Doppler frequency, Doppler spread and/or carrier phase offset. The UE may receive a measurement configuration (e.g., indicating the number of OFDM symbols, DL-RS resource ID) that causes the UE to make measurements to determine the Doppler frequency, Doppler spread and/or carrier phase offset. The UE may receive a request, configuration, or indication to report the Doppler frequency, Doppler spread and/or carrier phase offset at an indicated time instance based on the reference time (e.g., at 4T and 7T in the example shown in FIG. 13, as further described below), reference path, and/or any other suitable reference signal information.

In another example, the UE may be requested or configured (or the UE may otherwise determine) to associate the Doppler estimates (e.g., estimated Doppler frequency, Doppler spread or carrier phase offset) or carrier offset information with one or more additional measurements (e.g., timing, power, angle). Some illustrative measurement combinations include: Doppler estimates and power measurements; Doppler estimates and phase measurements; Doppler estimates and timing measurements; angle measurements and timing measurements; angle measurements, phase measurements and timing measurements; or Doppler estimates, angle, timing, power and phase measurements.

In another example, the UE may be configured to or receive a request to report Doppler shift or Doppler spread values at an indicated time instance or during an indicated range of time instances or range of ToAs.

According to certain embodiments of this disclosure, descriptions for how the UE performs spatial measurements are provided as follows.

In one example, the UE may be configured to report spatial information for an indicated time instance. For example, the UE may report the AoA of a 1^{st} DL-RS by indicating a 2^{nd} DL-RS, which could signify that the 1^{st} DL-RS arrived at the UE from the same direction as the 2^{nd} DL-RS. The UE may report the DL-RS resource ID of the 2^{nd} DL-RS as the AoA. The UE may report a second set of IDs, which may include more than one ID corresponding to more than one DL-RS, to indicate that more than one AoA is associated with the 1^{st} DL-RS. For example, the indication of more than one AoA may be used to determine that the 1^{st} DL-RS was (for at least one received path) reflected off of one or more objects before arriving at the UE.

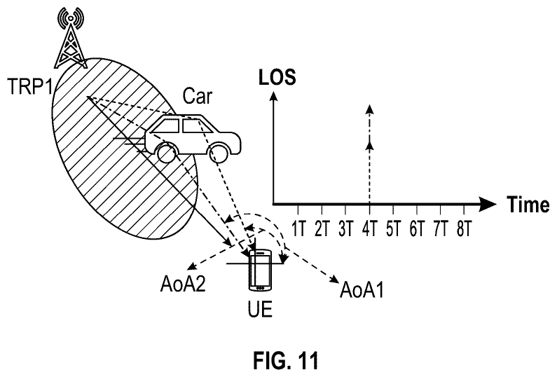

FIG. 11 shows an illustrative example of a DL-RS having more than one AoA at a single ToA. In the example of FIG. 11, the UE receives signals corresponding to reflections off of two discrete portions of the car (which represents any suitable target object). These two signals arrive with different AoAs, namely AoA1 and AoA2, but with similar ToAs (namely 4T). As a result, the UE may report more than one DL-RS ID or more than one AoA for the single time instance.

In another example, the UE may receive a threshold (e.g., RSRP or RSRP per path or time instance) value from the network. Then, the UE may determine to report spatial information for the 2^{nd} DL-RS (e.g., with respect to a 1^{st} DL-RS that serves as a reference) if the power measurement for the 2^{nd} DL-RS is above the threshold (where the threshold may be an absolute value or a difference based on a comparison to the reference signal).

According to certain embodiments of this disclosure, descriptions of evaluating and handling measurement uncertainty are provided as follows.

In certain embodiments, the UE may determine to, be configured to, or receive a request to report uncertainty for each time, power, and/or phase measurement. The uncertainty may be expressed in terms of a range of the corresponding units (e.g., second, degree, dB, dBm) or in terms of statistics (e.g., mean, standard deviation, variance).

According to certain embodiments of this disclosure, descriptions of multipath measurements and events that trigger measurement reporting are provided as follows.

A measurement instance may be defined as follows. The measurement instance may be an occasion where the UE makes measurements on the received DL-RS. The measurement instance may otherwise or additionally correspond to an occasion when the UE makes measurements on a received DL-RS symbol. The measurement instance may otherwise or additionally correspond to an occasion where the UE makes measurements on one or more received DL-RS symbols (e.g., one or more slots of DL-RS symbols, or one or more repetitions of the DL-RS).

The UE may receive an indication of the measurement instance from a wireless network. For example, the UE may be configured to make measurements on one or more particular DL-RS resources (e.g., one resource consisting of four repetitions of the DL-RS, where one occasion may correspond to measurements recorded at one slot with eight or any other suitable number of DL-RS symbols).

In one example, the UE may determine to report a first measurement at an instance of a configured measurement unit (e.g., at a time instance or at an angle instance) if a difference in the measurements recorded at a k^{th} measurement instance and a k+1^{th} measurement instance is greater than the threshold.

In another example, the UE may determine to report a second measurement (e.g., measuring a second property of a DL-RS) based on an association with or outcome of the first measurement (e.g., measuring a first property of the DL-RS). For example, the first measurement may indicate a time of arrival. If this time of arrival information satisfies a reporting trigger condition, then the UE may determine to perform the second measurement to indicate an angle of arrival (e.g., corresponding to the previously-indicated time of arrival). If the UE measures more than one second measurement as being associated with the first measurement (e.g., multiple AoAs for a single ToA, e.g., as shown and described in connection with FIG. 11), then the UE may determine to report all of the second measurements, or the UE may determine to report a processed value based on all of the second measurements (e.g., the UE may choose to report a particular one of the multiple second measurements, an average of the multiple second measurements, a largest or smallest one of the multiple second measurements, or a range or standard deviation associated with the multiple second measurements). If the UE reports a processed value based on all of the second measurements, the UE may also indicate the processing that occurred to generate the processed value (e.g., the UE may indicate that it processed an average, range, largest, smallest, or particular one of the second measurement values). Considering cases where multiple second measurements are associated with a single first measurement, in certain embodiments, the UE may be configured to report one or more processed value based on the multiple second measurements; in other embodiments, the UE may be configured to report all of the values of the second measurements.

According to certain embodiments of this disclosure, descriptions of measurement and reporting trigger conditions related to the first measurement (e.g., where the first measurement is at least as described above) are provided as follows.

In one example, the UE may determine to make the second measurement if the first measurement or a quantity associated with the first measurement is above a threshold. For example, if the first measurement is a power measurement, then the UE may determine to make the second measurement (e.g., a time of arrival, angle of arrival, spatial measurement, phase measurement, or any other suitable measurement) if the power measurement at a time instance (e.g., at a present time) is greater than the threshold. In another example, the UE may determine to report ToA or relative ToA of the time instance if the power measurement at the instance is above the threshold. In another example, the UE may determine to report the power measurement if the uncertainty (e.g., range, standard deviation, or variance) of the ToA or relative ToA is less than the threshold or within a maximum allowable uncertainty range. In accordance with certain embodiments of this disclosure, additional and nonlimiting examples of thresholds, first, and second measurement include: (i) First measurement: power measurement at a time instance; Second measurement: time of arrival at the time instance; Threshold: power level; (ii) First measurement: power measurement at a time instance; Second measurement: phase measurement at the time instance; Threshold: power level; (iii) First measurement: time of arrival at a time instance; Second measurement: phase measurement at the time instance; Threshold: power level; (iv) First measurement: time of arrival at a time instance; Second measurement: Doppler measurement at the time instance; Threshold: power level; (v) First measurement: time of arrival at a time instance; Second measurement: AoA measurement at the time instance; Threshold: power level; (vi) First measurement: time of arrival at a time instance; Second measurement: AoA measurement at the time instance; Threshold: uncertainty of time of arrival measurement.

In another example, the UE may determine to report the second measurement based on comparing the difference between the respective first measurements at the k^{th} and k+1^{th} measurement to a threshold (e.g., the UE may determine to report if the difference is greater than or less than the threshold). For example, if the first measurement is RSRP at a time instance (e.g., that may be defined with respect to a time window of a measurement), and the difference in the RSRP at the time instance corresponding to the k^{th} and k+1^{th} measurement occasions is greater than the threshold, the UE may determine to report the second measurement (e.g., AoA, ToA, relative ToA, absolute phase, phase difference) as is associated with the first measurement.

According to certain embodiments of this disclosure, examples of first and second measurements requested by the network are provided as follows.

In one example, the UE may receive a request from the network to report AoAs or spatial information for the indicated DL-RS resource at the indicated time instance or the indicated time of arrival. The indicated time instance may be defined with respect to a reference time (e.g., an absolute time, a relative time, a time defined with respect to a signal transmission time, a time defined with respect to a signal propagation time, a time defined with respect to a measurement time window, or any combination thereof). For example, the UE may receive a request from the wireless network to report a relative time based on a first path (e.g., as associated with the DL-RS). Through communication with the wireless network, the UE may indicate spatial information using a DL-RS or UL-RS resource ID. For example, the UE may report to the network that the UE received indicated DL-RS from the direction that the UE received a particular signal (e.g., CSI-RS #3) or the direction that the UE transmitted a particular signal (e.g., SRS #1). In another example, the UE may be configured with a RSRP threshold which is used by the UE to determine whether the observed or measured RSRP at a time instance is above the threshold or not; the UE may then determine to report the measured DL-RS when the corresponding RSRP is above the threshold.

In another example, the UE may receive a request from the network to report AoAs or spatial information for the indicated DL-RS resource at the indicated range of time or range of time of arrival. The range of time of arrival may be defined with respect to a reference time.

In another example, the UE may receive a request from the network to report RSRP or time of arrival at an indicated AoA or for an indicated spatial information. The time of arrival may be defined with respect to a reference time (e.g., time of arrival of the first path). The AoA may be defined with respect to a reference angle. The spatial information may be defined as a reference DL-RS. For example, the UE may receive a request to report RSRP for the indicated DL-RS for a direction that the UE received the signal (e.g., CSI-RS #2), and this signal may be the reference DL-RS.

In another example, the UE may receive a request to report a range of AoAs for an indicated Doppler shift or Doppler spread value. The request may also, for example, include an associated time instance, AoA or spatial information.

In another example, the UE may receive a request to report a delay spread of the channel for indicated DL-RS. The UE may also receive a request to report spatial information or angle of arrivals for the delay spread. The UE may report more than one aspect of the spatial information or more than one angle of arrival that are associated with the delay spread.

In another example, if a first condition (e.g., RSRP is above the threshold) associated with the first measurement is satisfied for an indicated quantity (e.g., an indicated time instance), the UE reports first measurement (e.g., AoA). Then, if a second condition (e.g., target velocity above the threshold) is satisfied (e.g., for the same signal that was used in connection with the first measurement), then the UE reports a second measurement (e.g., Doppler information).

The UE may receive the following illustrative and nonlimiting information in the request sent from the network: periodicity of measurements (e.g., how often the UE should measure); duration of measurements (e.g., how long the UE should measure); periodicity of the report (e.g., how often the UE should report); thresholds (e.g., RSRP) for determining whether to report an associated measurement, e.g., the UE may determine to report AoA for the indicated time instance if the RSRP of the received DL-RS is greater than the threshold; duration of the measurement and report (e.g., defining a time interval that the UE should use in connection with the measurements and the reporting); or reference information to use (e.g., reference measurement, reference DL-RS).

According to certain embodiments of this disclosure, descriptions of power thresholds and related reference information are provided as follows.

In one example, the UE may determine to report a measurement (e.g., power, phase, AoA) at a time instance based on comparing the difference between the measurement at the previous time instance and the measurement at the present or current time instance to a threshold (e.g., if the difference is larger than the power threshold value, the UE may determine to make the reporting).

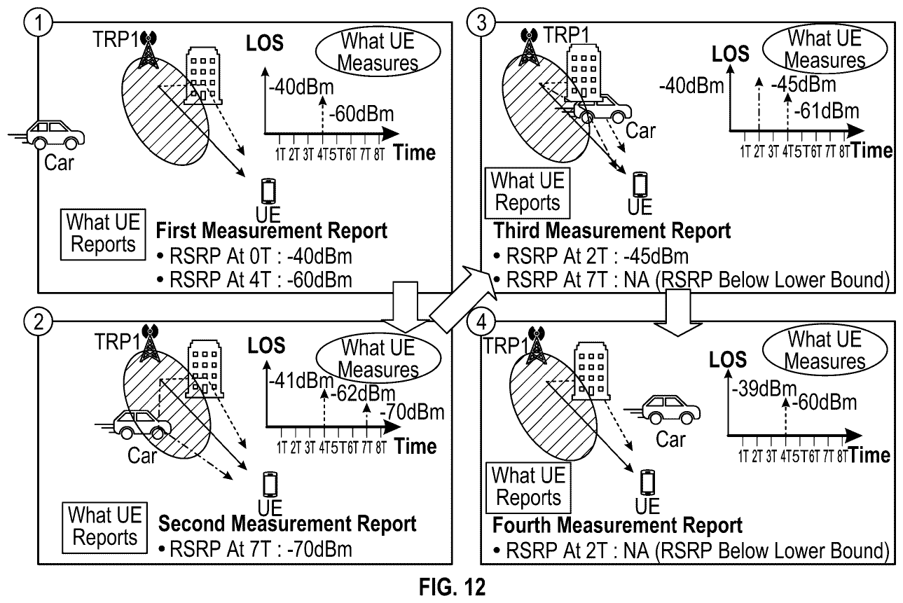

FIG. 12 shows an illustrative sequence of measurement instances and corresponding power difference reporting. For example, the power difference reporting may be used by a UE (e.g., based on comparing the respective power differences to one or more power difference threshold) to determine one or more aspects (e.g., one or more second measurements) of measurement reporting. In the example of FIG. 12, the power difference threshold is set at 5 dB. As shown in FIG. 12, The UE measures the transmitted DL-RS from TRP1 at 0T and 4T; the DL-RS measured at 0T may correspond to a LOS (line-of-sight) transmission. The UE may report 0T as the reference time to the network. The DL-RS measured at 4T may be the reflected DL-RS. As shown in the first panel (e.g., corresponding to a first measurement instance, occasion, and/or report) of FIG. 12, the UE reports the measured RSRP at 0T and 4T as −40 dBm and −60 dBm, respectively.

In one example, the first measurement instance may be the reference measurement. The UE may follow a procedure to determine the reference measurement as described above, at least in connection with receiving assistance information about the reference measurement.

In the second panel or measurement instance/occurrence/report shown in FIG. 12, the UE measures the transmitted DL-RS at 0T, 4T and 7T. The measured power is −41 dBm, −62 dBm and −70 dBm. Moreover, the UE observes a signal at 7T for the first time (i.e., the previous measurement instance did not include an observation at 7T). Because the difference in the signal power measurement at 7T between the first and second measurement instances is greater than the threshold value, the UE determines to report the measurement at 7T (as annotated in the second panel of FIG. 12). Because the differences in the power measurement at 0T and 4T between the first and second measurement instances is less than the threshold, the UE determines not to report these measurements (which is why corresponding reporting is not annotated in the second panel of FIG. 12). The UE may determine (e.g., based on a configuration from the network and/or based on logic of the UE) that the received power observed at 7T may have been received due to reflection off of a new object (e.g., an object that was not in the UE's field-of-view at the first measurement instance).

In the third measurement instance of FIG. 12, the UE measures the DL-RS as being close to zero-power at 7T. The UE also, for the first time in the measurement instances of FIG. 12, measures a received power from the DL-RS at 2T. Because the difference in measured power at 2T and 7T between the second and third measurement instances are each larger than the threshold, the UE reports the measured powers at 2T and 7T (as annotated in the third panel of FIG. 12). In particular, the UE may report the received power at 2T to the network, and the UE may also report that the power at 7T is not still observable. The UE may determine (e.g., based on a configuration from the network and/or based on logic of the UE) that the received power observed at 2T may have been received due to reflection off of a new object (e.g., an object that was not in the UE's field-of-view at the first measurement instance), and the disappearance of the received power that was previously observed at 7T may indicate that a mobile object moved out of the UE's field-of-view.

In the fourth measurement instance of FIG. 12, the UE did not observe significant received power on the DL-RS at 2T. The UE reports to the network that the power at 2T is not observable, as annotated in the fourth panel.

According to certain embodiments of this disclosure, indications of static and dynamic elements measured by the UE are provided as follows.

In one example, the UE may receive an indication, from the network, about one or more time ranges that contain static or dynamic measurements. For example, in multipath channels, a path that corresponds to a static measurement may be observed at a time instance or within an indicated range. The indication of static or dynamic measurements may permit the UE to determine how to focus its measurement resource (e.g., path detection algorithm, beam steering) to gather desired information within the indicated range.

Some illustrative and nonlimiting examples of causes of static measurements may be the presence of a large obstacle (e.g., building, ground). Some illustrative and nonlimiting examples of dynamic measurements may be the presence of a mobile object (e.g., a car, other suitable vehicle, or any other mobile object) that passes through multiple positions (e.g., including positions that reflect and positions that do not reflect signals arriving at the UE) with respect to the UE and the wireless network transmission point.

For example, in the illustrative sequence of measurement instances shown in FIG. 12, the signal observed at 4T (e.g., which may be determined to be a static path) may be determined to correspond to a static element or object in the environment. In another example, the UE may receive assistance information from the network indicating that between 3T and 5T, the UE should expect to receive a signal corresponding to a static path (e.g., RSRP at a time instance between 3T and 5T may be observed consistently).

In certain embodiments, the UE may receive an indication (e.g., a time range) from the network about the timing of expected dynamic measurements. A dynamic measurement may include any measurement that appears or disappears at a relevant time instance. For example, in connection with the illustrative sequence of measurement instances shown in FIG. 12, the UE may receive an indication form the network that between 6T and 8T, the UE may observe a dynamic measurement corresponding to a signal path that appears and/or disappears.

In certain embodiments, the UE may be configured to report differential measurements (e.g., a difference between respective measurements recorded at time instances associated with k^{th} and k+1^{th} measurement instances) for one or more previously-indicated static measurements.

According to certain embodiments of this disclosure, descriptions of phase or AoA measurements for multipath signals are provided as follows.

In one example, the UE may determine to report phase or AoA differences for the indicated DL-RS per measurement instance based on comparing phase measurements at time instances associated with k^{th} and k+1^{th} measurement instances.

FIG. 13 shows an illustrative sequence of measurement instances and corresponding reporting, including of phase difference measurements. As shown in FIG. 13, at the second measurement instance, the UE may determine to report a phase difference between phase measurements made at t=0 (e.g., at “LOS” or 0T) for the first and second measurement instances; the UE may also determine to report the phase difference between phase measurement made at t=4T for the first and second measurement instances, as well as the introduction of a signal at t=7T with a RSRP of −70 dBm. At the third measurement instance, the UE may determine to report phase differences between the second and third measurement instances for the respective phase measurements made at 0T, 4T, and 7T. At the fourth measurement instance, the UE may determine to report phase differences between the third and fourth measurement instances for the respective phase measurements made at 0T and 4T, as well as the disappearance of the observed signal at 7T.

In certain embodiments, the UE may determine to make a phase difference measurement at a time instance only if a phase measurement is made at the time instance of the present measurement instance and at the corresponding time instance of the previous measurement instance. In certain embodiments, the UE may measure and/or report an absolute phase measurement associated with the first measurement instance so that the UE and/or the wireless network has a reference phase measurement (e.g., to be used in the subsequent calculation of a phase difference).

In another example, the UE may determine to make a phase (or Doppler) or phase difference measurement at a time instance if the RSRP measured at the time instance is above or equal to a threshold. If the measured RSPR is below the threshold, then the UE may not make phase or phase difference measurement.

In another example, the UE may make an absolute phase measurement based on receiving a request or a configuration to make the absolute phase measurement during the indicated range.

In another example, the UE may report a difference between a phase or AoA measurement and a corresponding reference phase or AoA measurement. For example, the UE may report the phase differences between corresponding phase measurement at t=0 and t=4T of the first and second measurement instances depicted in the illustrative example of FIG. 13.

According to certain embodiments of this disclosure, differential AoA measurements that can be used in connection with multipath signals are provided as follows.

In one example, the UE may determine to report the AoA if a difference in AoA between the k^{th} and k+1^{th} measurement occasions is larger than the threshold. In certain embodiments, the AoA is defined with respect to a reference angle. For example, the AoA of the first arriving DL-RS may be used to define the reference angle.

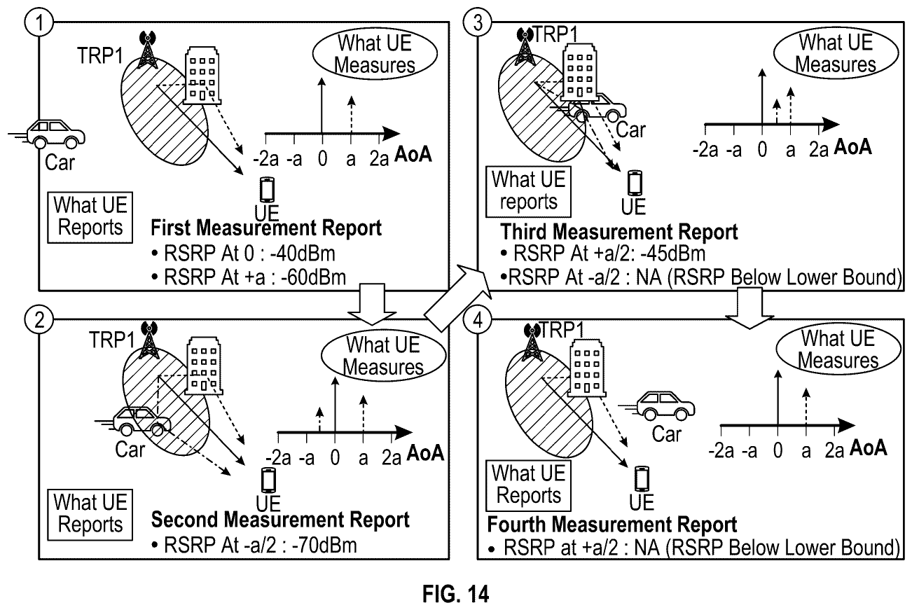

FIG. 14 shows an illustrative sequence of measurement instances and corresponding AoA reporting. In the first measurement instance of FIG. 14, the UE receives signals at relative AoA values of 0 degrees and +a degrees, where these relative AoA values are measured with respect to a reference angle (e.g., where the reference angle is the LOS signal in FIG. 14, but the reference angle may also be derived from the signal that arrived first, the signal with the highest RSRP, or any other suitable signal), and a represents an angle measured with respect to the reference angle (e.g., in degrees). In the second measurement instance of FIG. 14, the UE observes a new AoA at −a/2 degrees from the reference. Thus, the UE determines to report the new AoA to the network. In the third measurement instance, the UE observes a new AoA at +a/2 degrees, and the UE does not continue to observe the AoA at-a/2 degrees. Thus, the UE determines to report RSRP at relative AoAs of +a/2 and −a/2 to the network. In the fourth measurement instance of FIG. 14, the UE does not continue to observe the AoA at +a/2 degrees. Thus, the UE determines to report the updated RSRP (e.g., below a lower bound that indicates receiving a reliable signal) at +a/2 degrees. In certain embodiments, the UE may determine to report RSRP for a relative or absolute AoA if the RSRP is above a threshold (e.g., above the lower bound). In certain embodiments, the UE may determine to report time of arrival or relative time of arrival for each reported AoA.

In another example, if more than one ToA are observed at a single AoA, the UE may determine to compute the average of these multiple ToAs, or to choose the median value of the multiple ToAs. Moreover, the UE may indicate to the network whether the average or median ToA is reported. In another example the UE may be configured to report all of the multiple ToAs associated with a single AoA.

According to certain embodiments of this disclosure, descriptions of a measurement window are provided as follows.

In one example, the UE may be configured for a range (e.g., of absolute or relative time, AoA, ToA, RSRP, or any other suitable metric) across which to make measurements. Upper and/or lower bounds of the range may be defined with respect to any suitable reference. The network may determine to configure the range according to one or more capability (e.g., which corresponds to a capable measurement range) of the UE.

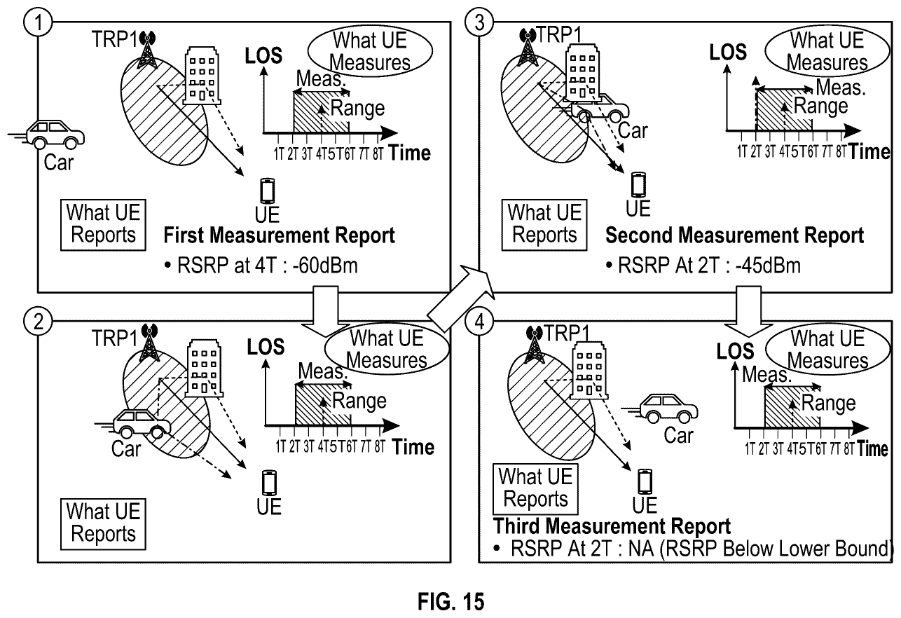

FIG. 15 shows an illustrative sequence of measurement instances and corresponding measurement ranges (e.g., which may be a whole or subset of a measurement window or a time window). As shown in FIG. 15, the UE may be configured or requested to make measurements based on the selected (or configured) range (e.g., where the range may be between 2T and 6T, which may be defined with respect to the time of the first-arriving DL-RS). The UE determines to make measurements on the indicated DL-RS or received power through the time of the indicated range. For example, as shown in FIG. 15, the UE measures and reports that the RSRP=−60 dBm for the indicated DL-RS at the timing instance 4T. Because the measurement occurs within the measurement range, the UE determines to report the RSRP measured at the timing instance 4T. In the second measurement instance of FIG. 15, despite continuing to measure RSRP=−60 dBm for the indicated DL-RS at timing instance 4T, the UE does not report any measurements because it observes a static environment within the indicated time range. In the third measurement instance of FIG. 15, the UE makes an additional RSRP measurement for the indicated DL-RS at timing instance 2T. Because the UE did not previously (i.e., in measurement instances 1 or 2 of FIG. 15) make any measurement at 2T, the UE determines to report the RSRP=−45 dBm observed at the timing instance 2T to the network. In the fourth measuring instance of FIG. 15, the UE no longer measures a significant level of power at 2T. Because this disappearance of the signal at 2T indicates a power difference when comparing the third and fourth measurement instances at the corresponding 2T time instances, the UE determines, at the fourth measurement instance, to report the power level (e.g., being below the lower bound, as annotated) at 2T.

In another example, the UE may be configured with more than one windows or range(s) of measurement, and each window or range may be associated with an index. The UE may also receive a signal (e.g., a lower layer signal such as DCI, MAC-CE) indicating which window or range is activated or deactivated. The corresponding activation or trigger condition may include one or more window or range indices.

According to certain embodiments of this disclosure, descriptions of a moving measurement window (e.g., time window) or measurement range are provided as follows.

In one example, the UE may be configured with a measurement range where the location of the measurement window is determined based on the number of measurements or the index of the measurement instance. The network may provide rules and/or at least one configuration to the UE to determine aspects of the moving measurement range.

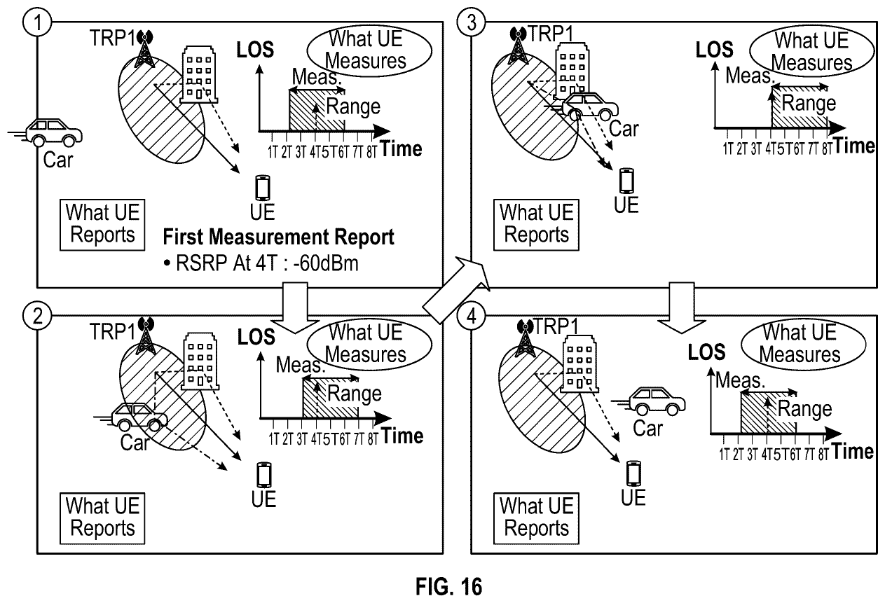

FIG. 16 shows an illustrative sequence of measurement instances with moving measurement windows. In the first measurement instance of FIG. 16, the UE is configured with a range between 2T and 6T. The UE measures RSRP=−60 dBm for the indicated DL-RS at timing instance 4T. Thus, as annotated, the UE reports to the network the RSRP value measured at 4T. In the second measurement instance of FIG. 16, the UE determines to shift the range by 1T compared to the previous range (e.g., the measurement range is updated to being between 3T and 7T). Compared to the first measurement instance, the UE does not make any new measurement during this updated range of the second measurement instance. In the third measurement instance of FIG. 16, the UE determines to again shift the range by 1T compared to the previous range (e.g., the measurement range is updated to being between 4T and 8T). Compared to the second measurement instance, the UE does not make any new measurements during this updated range of the third measurement instance. In the fourth measurement instance of FIG. 16, the UE determines to again shift the range by 1T compared to the previous range (e.g., the measurement range is updated to being between 4T and 8T). Compared to the third measurement instance, the UE docs not make any new measurements during this updated range of the fourth measurement instance. In this illustrative example of FIG. 16, the UE does not report any measurements for the second, third or fourth measurement instances.

According to certain embodiments of this disclosure, descriptions of the contents of the measurement batch and/or batch reporting are provided as follows.

In certain embodiments, the UE may report measurements to the network in a semi-static message (e.g., LPP, RRC). The corresponding report may include any one or more of the following illustrative and non-limiting elements: a timestamp (e.g., expressed in terms of SFN, slot index, frame index, subframe index, absolute time) associated with each measurement, e.g., indicating when the measurement was made; a timestamp (e.g., expressed in terms of SFN, slot index, frame index, subframe index, absolute time) associated with the measurement report, e.g., indicating when the report was made; a timestamp associated with the measurement report, e.g., indicating when the report was made; a timestamp for each measurement, e.g., which may be a relative time with respect to the timestamp associated with the measurement report; a power measurement (e.g., RSRP); a phase measurement; an angle measurement; or a timing measurement.

In certain embodiments, the UE may indicate the number of measurements (e.g., the number of measurement instances) in the report. For example, in the example illustrated in FIG. 12, the UE reports measurements for each of the four illustrative measurement instances. In the example illustrated in FIG. 13, the UE reports measurements for each of the three illustrative measurement instances.

In one example, the UE may also indicate any of the following correlation information to the network (e.g., if this information is requested by the network or specified in a configuration of the UE). The correlation between Rx antennas may be indicated. For example, the UE may indicate correlation between Rx antennas to assist the network in refining or determining AoA values. In certain embodiments, the correlation between Rx antennas may be expressed in a form of correlation matrix. In certain embodiments, the correlation between antennas may be a spatial correlation.

The UE may be configured to provide a maximum number of measurements (e.g., based on a capability or bandwidth of the UE or the network) in the report. The UE may be configured or may determine to accumulate respective measurements until the UE reaches the configured number of measurements.

The UE may determine to include an indicator in the measurement to report any possible changes in the condition at the UE. Some illustrative and nonlimiting changes that may be reported by the UE are provide as follows.

A different RX beam is used. In one example, the UE may indicate one or more Rx beam indices selected from a group of configured Rx beam indices. In another example, the UE may indicate a flag in the measurement report. In certain embodiments, a flag value of 1 may indicate that the UE is using a different Rx setup from the previously reported measurement; a flag value of 0 may indicate that the UE is using the same Rx setup form the previously reported measurement.

UE rotation has occurred. In one example, the UE may indicate a flag in the measurement report. In certain embodiments, a flag value of 1 indicates that the UE has rotated since the previously reported measurement, and/or an angle associated with this rotation is above the threshold; a flag value of 0 may indicate that the UE has not rotated, or an angle associated with a possible rotation is below the threshold. In another example, the UE may indicate how much the UE has rotated since the previous measurement.

UE movement has occurred. In one example, the UE may indicate in the measurement report a flag. In certain embodiments, a flag value of 1 indicates that the UE moved since the last reported measurement, and/or an amount of movement is above a threshold (e.g., provided in configuration of the UE); a flag value of 0 may indicate that the UE has not moved since the last reported measurement, and/or the amount of the possible movement is less than the threshold. In another example, the UE may indicate how much the UE has moved since the previous measurement.

With reference at least to FIGS. 12-16, any respective measurement instance (e.g., as depicted by a respective panel) may be a first measurement instance (e.g., that includes a first measurement range or measurement window, e.g., which is a part or whole of a first time window). With further reference at lest to FIGS. 12-16, and in particular with reference to the #1 through #4 panel annotations and the corresponding sequence flow (as indicated by the arrows), any measurement instance (e.g., that includes a second measurement range or measurement window, e.g., which is a part or whole of a second time window) following a first measurement instance may be a second measurement instance. In certain embodiments, the second measurement instance directly follows the first measurement instance; in other embodiments, one or more different measurement instances may intervene between first and second measurement instances. As described in connection with certain embodiments of this disclosure, a present time window (e.g., as is associated with a second measurement range) may be a second time window and a prior time window (e.g., as is associated with a first measurement range) may be a first time window.

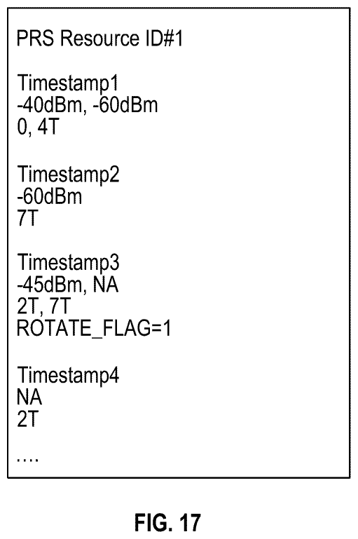

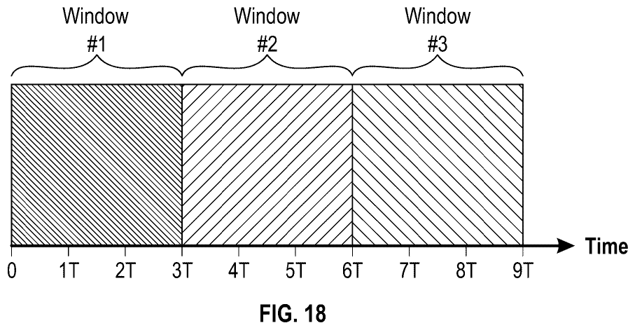

FIG. 17 shows an example of measurement report. The values of the example measurement report of FIG. 17 correspond to the illustrative sequence of measurements in FIG. 12. Similar reports may be provided for other illustrative sequences of measurement provided in this disclosure or for other illustrative sequences of measurement that, despite not being explicitly shown, are consistent with certain embodiments of this disclosure.

According to certain embodiments of this disclosure, descriptions of events that trigger increased measurement accuracy are provided as follows.

In one example, the UE may be configured with more than one measurement window, time window, or measurement range. The UE may determine to make more accurate measurements within any one of these multiple time windows if a measurement condition is satisfied. For example, the UE may determine to make RSRP measurements for the configured time windows. If one of these RSRP measurements is above a threshold during a particular time window, then the UE may determine to make more accurate measurements (e.g., where the more accurate measurements increase a precision/granularity of the RSRP or any other suitable property) during the time window.

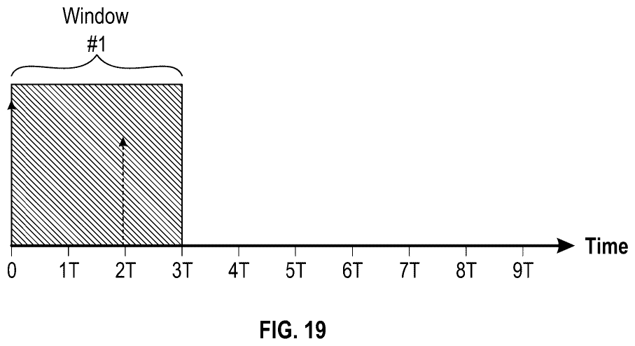

FIG. 18 shows an example of multiple times associated with a UE measurement procedure. FIG. 19 shows an example of the UE determining to activate one of multiple possible measurement times to achieve a more granular measurement within the activated time.

As illustrated in FIG. 18, the UE is configured with three time windows. The UE makes RSRP measurement for each time window. Start and end times for each measurement may be defined for each respective time window with respect to a reference time (e.g., time 0 or 0T). In the example of FIG. 18, as further shown in FIG. 19, the RSRP measurement for window #1 is greater than the threshold. The UE therefore determines to make RSRP and ToA measurement at the configured time granularity during window #1, as illustrated in FIG. 19. By activating time window 1 and deactivating at least one other time window, the UE may determine to make a more granular measurement, and/or it may increase a physical granularity capability, during the activated time window.

According to certain embodiments of this disclosure, descriptions of measurement occasions are provided as follows.

In one example, a measurement occasion may correspond to a range or window during which the UE makes measurements. In another example, a measurement occasion may be an occasion in which the UE receives one instance of a DL-RS or repetitive instances of the DL-RS.

In one example, the measurement occasions may be configured by the network. The configured measurement occasions may be periodic, semi-persistent or aperiodic. Semi-persistent measurement occasions may be activated and/or deactivated by the network.

In certain embodiments, semi-persistent measurement occasions may be activated and/or deactivated by the network via MAC-CE. During the activated period or window, the UE may determine to make measurements at periodically occurring measurement occasion.

In certain embodiments, aperiodic measurement occasions may be triggered by the network with a lower layer signal (e.g., DCI). In one example, the UE may receive the trigger at least N time units (e.g., slots, symbols, frames, subframes, seconds) prior to the measurement occasion.

According to certain embodiments of this disclosure, descriptions for how the UE holds measurements and/or waits to make new measurements are provided as follows.

In certain embodiments, the UE may determine to make measurements and report these measurements at a configured time if a validation condition is satisfied. The validation condition may be configured by the network such that the reported measurement or information is determined to be valid or is associated with a high level of confidence. If the validation condition is not satisfied, then the UE may determine not to report the measurement or information to the network.

In certain embodiments, the UE may receive a request or a configuration to report Doppler information. The UE may determine the Doppler information and report it at a configured time (e.g., where the configured time may specify N slots or frames after the UE determines the information). The UE may determine to report the Doppler information at the configured time if the RSRP measurement at the time instance or path associated with Doppler information is above the threshold at the configured time.

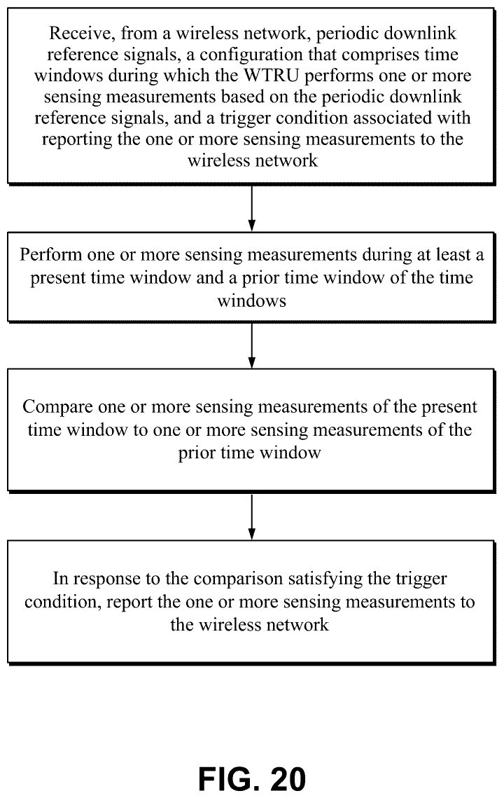

According to certain embodiments of this disclosure, FIG. 20 shows an illustrative and nonlimiting method for using a UE to make sensing measurements and report the sensing measurements to a wireless network is provided as follows. As described in connection with FIG. 20, the UE may correspond to UE 102, any suitable WTRU as described above, or any other suitable device; the wireless network may be a RAN 104; and the UE may communicate with the wireless network via one or more base stations (e.g., any one or more of the base stations 114a-b), one or more nodes (e.g., any one or more of the eNode-Bs 160a-c and/or any one or more of the gNBs 180a-c). In certain embodiments, the method of FIG. 20 is performed by a UE coupled to a wireless network as depicted in FIG. 1A, FIG. 1C, and/or FIG. 1D.

As shown in the method of FIG. 20, the UE is configured to receive, from a wireless network, periodic downlink reference signals, a configuration that comprises time windows during which the WTRU performs one or more sensing measurements based on the periodic downlink reference signals, and a trigger condition associated with reporting the one or more sensing measurements to the wireless network. In certain embodiments, the UE is configured to observe periodic DL RSs (e.g., with a particular periodicity and/or DL resource IDs) to make measurements for sensing (e.g., of mobile objects).

In certain embodiments, the periodic downlink reference signals may include the signals of FIG. 5 with periodicity as annotated therein; the signals of FIG. 7 with the periodicity indicated by Occasion #1 and Occasion #2; a signal with periodicity as indicated by repetitive observations across multiple measurement instances (e.g., as shown at least in FIGS. 10 and 12-16), any other suitable periodic symbol, or any combination thereof.

In certain embodiments, the configuration is received as shown in FIGS. 3-4. In certain embodiments, the time windows of the configuration include the whole or a portion of a measurement window (e.g., as shown in FIG. 5, FIG. 18, or FIG. 19). In certain embodiments, the configuration may specify details of the reporting as shown in FIG. 17. In certain embodiments, the time windows of the configuration correspond to or include the measurement range (e.g., which may be a subset of a measurement or time window, as described previously) (e.g., as shown in FIGS. 15-16).

In certain embodiments, the trigger condition is triggered when any property being measured by the UE changes, with respect to present and previous observations of the UE, by above a threshold amount. For example, the annotated reporting outcomes associated with respective measurement instances of FIGS. 12-16 may be indicative of a trigger condition having been satisfied (e.g., where the report provides indications of which property and corresponding property value satisfied the trigger condition).

In certain embodiments, the UE receives an indication (e.g., where the indication may be a part of the configuration and/or it may be a trigger condition) from the network. The indication may include at least a measurement granularity, a power threshold, a requested measurement range (e.g., [0T, 8T], as shown at least in connection with FIG. 12 or [2T, 6T] as shown at least in connection with FIG. 14, where the intervals T may be defined with respect to a reference time (e.g., corresponding to the arrival of a first path)) and a maximum number of measurements per report (e.g., it may be the case that N=3 in FIG. 13 because no more than three measurements are provided in any one report).

As further shown in the method of FIG. 20, the UE is also configured to perform one or more sensing measurements during at least a present time window and a prior time window of the time windows. In certain embodiments, the UE is configured with periodically occurring time windows (e.g., there a time window may be referred to as a monitoring window, and may be equal to a measurement range or may include a measurement range as a subset thereof, e.g., as shown in FIGS. 15-16) (e.g., as shown in FIG. 5) during which the UE makes measurements on the DL RS. In certain embodiments, the UE may also be configured with a maximum number of measurements (e.g., N measurements) to include in a report (e.g., the report of FIG. 17).

In certain embodiments, the one or more sensing measurements include any one or more of the abovementioned properties of a reference signal (e.g., including but not limited to any relative or absolute RSRP, ToA, AoA, phase) (e.g., as shown and described at least in connection with FIGS. 12-16). In certain embodiments, a present time window can refer to any one of the illustrative measurement instances shown in connection with FIGS. 12-16, or similar measurement instances, and the prior time window can refer to any earlier measurement instance, or similar measurement instances, e.g., as can be further understood at least with reference to the illustrative flows of instances shown in FIGS. 12-16.

As further shown in the method of FIG. 20, the UE is also configured to compare one or more sensing measurements of the present time window to one or more sensing measurements of the prior time window. For example, the UE may be configured to, based on the comparison, determine a difference between a present and a prior measurement of any property of the reference signal.

As further shown in the method of FIG. 20, the UE is also configured to, in response to the comparison satisfying the trigger condition, report the one or more sensing measurements to the wireless network compare one or more sensing measurements of the present time window to one or more sensing measurements of the prior time window.

In certain embodiments, if the difference in a measurement quantity (e.g., RSRP, or any suitable measurement quantity) for the DL-RSs received during discrete (e.g., consecutive) measurement occasions at corresponding time instances (e.g., within the indicated measurement range) exceeds a threshold (e.g., the power threshold), then the UE includes the measurement quantity and corresponding relative sample time information (e.g., a particular interval T within the indicated range, e.g., [0T, 8T]) in the measurement report. The UE may also provide the reference time in this measurement report. The UE may also include N measurement instances in this measurement report.

In accordance with certain embodiments of this disclosure, based on the reports from the UE, the network can detect the changes in the environment, estimate degradation in quality of communication, and, in response to a sufficiently severe degradation in quality, find and propose an alternate path for communication with the network to maintain a stable connection between the network and the UE. In addition, overhead reduction can be achieved based on certain embodiments of the reporting approaches described in this disclosure.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network:
a configuration that comprises time windows during which the WTRU performs one or more sensing measurements based on periodic downlink reference signals, wherein each time window comprises a measurement range, and
a trigger condition associated with reporting the one or more sensing measurements to the wireless network;
receiving, from the wireless network, the periodic downlink reference signals;
performing one or more sensing measurements during at least a present time window and a prior time window of the time windows;
comparing one or more sensing measurements of the measurement range of the present time window to one or more sensing measurements of the measurement range of the prior time window; and
in response to the comparison satisfying the trigger condition, reporting the one or more sensing measurements to the wireless network.

2. The method of claim 1, wherein the configuration further comprises any one or more of a measurement granularity or a maximum number of measurements per report associated with the one or more sensing measurements, and the measurement range comprises:
a portion of a cyclic prefix associated with the time window, or
a portion of an orthogonal frequency division multiplexing symbol length associated with the time window.

3. The method of claim 1, wherein if the configuration does not comprise the measurement range as a subset of a respective time window, then performing the one or more sensing measurements is based on a maximum measurement range associated with the time windows.

4. The method of claim 1, wherein if the trigger condition does not comprise a measurement power threshold, then the reporting comprises a reference signal received power at each of the one or more sensing measurements.

5. The method of claim 1, wherein:
comparing the one or more sensing measurements comprises calculating at least one difference between at least one reference signal received power associated with the measurement range of the present time window and at least one reference signal received power associated with the measurement range of the prior time window;
satisfying the trigger condition comprises the at least one difference exceeding a threshold; and
if the at least one difference exceeds the threshold, then the reporting comprises the at least one reference signal received power associated with the measurement range of the present time window, a reference time, and at least one relative sample time associated with the at least one reference signal received power associated with the measurement range of the present time window.

6. The method of claim 1, wherein:
the configuration further comprises a maximum number of measurement instances to be included in the report; and
reporting the one or more sensing measurements comprises reporting respective one or more sensing measurements for each measurement instance of the maximum number of measurement instances.

7. The method of claim 1, wherein the configuration is based on a sensing capability of the WTRU, the sensing capability comprising at least one of: a capability to make measurements on specific types of downlink reference signals; a capable measurement periodicity; a capable reporting periodicity; a capability to perform simultaneous sensing and communication; a capability to determine location information of the WTRU; or a supported sensing type.

8. The method of claim 1, wherein the comparing and the reporting occur during or after the present time window.

9. The method of claim 1, wherein:
receiving the periodic downlink reference signals comprises receiving a first periodic downlink reference signal at a plurality of times; and
performing the one or more sensing measurements comprises determining respective time differences between the plurality of times.

10. The method of claim 1, wherein the trigger condition comprises a threshold difference between one or more sensing measurements of the present time window and a corresponding one or more sensing measurements of the prior time window.

11. The method of claim 1, wherein the trigger condition is based on any one or more of: a time of arrival, an angle of arrival, a spatial measurement, a power measurement, a Doppler measurement, or a phase measurement.

12. A wireless transmit/receive unit (WTRU) comprising:
a processer, and
a transceiver coupled to the processer, wherein the WTRU is configured to:
receive, from a wireless network:
a configuration that comprises time windows during which the WTRU performs one or more sensing measurements based on periodic downlink reference signals, wherein each time window comprises a measurement range, and
a trigger condition associated with reporting the one or more sensing measurements to the wireless network;
receive, from the wireless network, the periodic downlink reference signals;
perform one or more sensing measurements during at least a present time window and a prior time window of the time windows;
compare one or more sensing measurements of the measurement range of the present time window to one or more sensing measurements of the measurement range of the prior time window; and
in response to the comparison satisfying the trigger condition, report the one or more sensing measurements to the wireless network.

13. The WTRU of claim 12, wherein the configuration further comprises any one or more of a measurement granularity or a maximum number of measurements per report associated with the one or more sensing measurements, and the measurement range comprises:
a portion of a cyclic prefix associated with the time window, or
a portion of an orthogonal frequency division multiplexing symbol length associated with the time window.

14. The WTRU of claim 12, wherein if the configuration does not comprise the measurement range as a subset of a respective time window, then the WTRU is configured to then perform the one or more sensing measurements based on a maximum measurement range associated with the time windows.

15. The WTRU of claim 12, wherein:
to compare the one or more sensing measurements comprises calculating at least one difference between at least one reference signal received power associated with the measurement range of the present time window and at least one reference signal received power associated with the measurement range of the prior time window;
satisfying the trigger condition comprises the at least one difference exceeding a threshold; and
if the at least one difference exceeds the threshold, then the report comprises the at least one reference signal received power associated with the measurement range of the present time window, a reference time, and at least one relative sample time associated with the at least one reference signal received power associated with the measurement range of the present time window.

16. The WTRU of claim 12, wherein:
the configuration further comprises a maximum number of measurement instances to be included in the report; and
to report the one or more sensing measurements comprises reporting respective one or more sensing measurements for each measurement instance of the maximum number of measurement instances.

17. The WTRU of claim 12, wherein the configuration is based on a sensing capability of the WTRU comprising at least one of: a capability to make measurements on specific types of downlink reference signals; a capable measurement periodicity; a capable reporting periodicity; a capability to perform simultaneous sensing and communication; a capability to determine location information of the WTRU; a capability to provide Doppler information; or a supported sensing type.

18. The WTRU of claim 12, wherein the comparing and the reporting occur during or after the present time window.

19. The WTRU of claim 12, wherein:
to receive the periodic downlink reference signals comprises receiving a first periodic downlink reference signal at a plurality of times; and
to perform the one or more sensing measurements comprises determining respective time differences between the plurality of times.

20. The WTRU of claim 12, wherein the trigger condition:
comprises a threshold difference between one or more sensing measurements of the present time window and a corresponding one or more sensing measurements of the prior time window; and
is based on any one or more of: a time of arrival, an angle of arrival, a spatial measurement, a power measurement, a Doppler measurement, or a phase measurement.
